(19) United States
(12) Patent Application Publication
(10) Pub. No.: US 2018/0029232 A1
(43) Pub. Date: Feb. 1, 2018

(54) CONTROL APPARATUS AND ROBOT

(71) Applicant: Seiko Epson Corporation, Tokyo (JP)

(72) Inventors: Makoto OUCHI, Matsumoto (JP); Makoto KUDO, Fujimi (JP)

(21) Appl. No.: 15/662,403

(22) Filed: Jul. 28, 2017

(30) Foreign Application Priority Data
Jul. 29, 2016 (JP) 2016-149434

(51) Int. Cl. B25J 9/16

(52) U.S. Cl. CPC B25J 9/1674

(57) ABSTRACT

A control apparatus includes a processor that is configured to execute computer-executable instructions so as to control a robot, wherein the processor is configured to cause a display unite to display an operational screen, on which task information indicating each of a plurality of tasks performed by a robot provided with a force detecting unit is displayed, receive a parameter according to a task of the robot, which is indicated by selected task information once the processor receives the selection of the task information, and cause the display unite to display information indicating operation of the robot based on the received parameter.

### BACKGROUND

### 1. Technical Field

The present invention relates to a control apparatus and a robot.

### 2. Related Art

Research and development on a technique to control a robot provided with a force detecting unit based on an external force detected by the force detecting unit has been conducted.

In this regard, a robot teaching system that generates a teaching operational screen which includes guidance information for a teacher of a robot provided with a force sensor, adjusts a parameter for generating a job to define an operation command in a case where a predetermined task is performed which includes content of modifying operation of the robot based on a designation value input by the teacher on a teaching operational screen and a measured value from a force sensor, and generates a job in which the adjusted parameter is reflected is known (refer to JP-A-2014-166681).

However, in such a robot teaching system, the teacher is required to designate a designation value by determining the designation value, which needs to be designated according to a task that the teacher causes the robot to perform. For this reason, in some cases, it is difficult for low-skilled teachers to perform teaching with high accuracy in this robot teaching system.

### SUMMARY

An aspect of the invention is directed to a control apparatus comprising: a processor that is configured to execute computer-executable instructions so as to control a robot, wherein the processor is configured to: cause a display unite to display an operational screen, on which task information indicating each of a plurality of tasks performed by a robot provided with a force detecting unit is displayed; receive a parameter according to a task of the robot, which is indicated by selected task information once the processor receives the selection of the task information; and cause the display unite to display information indicating operation of the robot based on the received parameter.

According to this configuration, the control apparatus displays the operational screen, receives the parameter according to the task of the robot indicated by the selected task information once the selection of the task information is received, and displays the information indicating the operation of the robot based on the received parameter onto a display unite. Accordingly, the control apparatus can cause a user to easily perform input of the parameter according to the task performed by the robot.

In another aspect of the invention, the control apparatus may be configured such that a part or the whole of the plurality of tasks is a task indicated by task information stored in advance in a memory unit.

According to this configuration, in the control apparatus, a part or the whole of task information indicating each of the plurality of tasks performed by the robot is a task indicated by task information stored in advance in the memory unit. Accordingly, the control apparatus can cause the user to easily perform input of the parameter according to the task performed by the robot based on the task information stored in the memory unit.

In another aspect of the invention, the control apparatus may be configured such that a default value of the parameter according to the task, which is indicated by the selected task information, is determined in advance and the parameter is set to the default value in a case where the processor does not receive the parameter.

According to this configuration, the control apparatus sets the parameter to the default value in a case where the parameter is not received. Accordingly, the control apparatus can cause the user to easily perform input of the parameter according to the task performed by the robot based on the default value of the parameter.

In another aspect of the invention, the control apparatus may be configured such that the parameter is a parameter for controlling the robot based on an output value from the force detecting unit.

According to this configuration, in a case where the user selects certain task information, the control apparatus receives the parameter for controlling the robot based on the output value from the force detecting unit, which is the parameter according to the task of the robot indicated by the selected task information, and displays information indicating operation of the robot based on the received parameter onto the operational screen. Accordingly, the control apparatus can cause the user to easily perform input of the parameter for controlling the robot based on the output value from the force detecting unit, which is the parameter according to the task performed by the robot.

In another aspect of the invention, the control apparatus may be configured such that control based on the output value is impedance control and the parameter is an impedance parameter.

According to this configuration, in a case where the user selects certain task information, the control apparatus receives the parameter for controlling the robot through impedance control, which is the parameter according to the task of the robot indicated by the selected task information and displays information indicating operation of the robot based on the received parameter onto the operational screen. Accordingly, the control apparatus can cause the user to easily perform input of the parameter for controlling the robot through impedance control, which is the parameter according to the task performed by the robot.

In another aspect of the invention, the control apparatus may be configured to receive a termination condition to terminate control of the robot based on the output value and cause the display unite to display information based on the received termination condition.

According to this configuration, the control apparatus receives the termination condition to terminate the control of the robot based on the output value from the force detecting unit on the operational screen and displays the information indicating operation of the robot based on the received termination condition onto the operational screen. Accordingly, the control apparatus can cause the user to easily perform input of the termination condition to terminate the control of the robot based on the output value from the force detecting unit.

In another aspect of the invention, the control apparatus may be configured to cause the display unite to display information based on the output value.

According to this configuration, the control apparatus displays the information based on the output value from the force detecting unit onto the display unite. Accordingly, based on the information, which is based on the output value from the force detecting unit and is displayed on the operational screen, the control apparatus can cause the user to easily perform input of the parameter for controlling the robot based on the output value from the force detecting unit, which is the parameter according to the task performed by the robot.

In another aspect of the invention, the control apparatus may be configured such that a button to store the parameter received from the operational screen in a memory unit is included in the operational screen and the processor is configured to store parameter information indicating the parameter in the memory unit once the processor receives selection of the button.

According to this configuration, once the selection of the button to store the parameter received from the operational screen in the memory unit is received, the control apparatus stores the parameter information indicating the parameter in the memory unit. Accordingly, the control apparatus can output the parameter information stored in the memory unit to other devices.

In another aspect of the invention, the control apparatus may be configured such that the information is a result of performing simulation of the operation.

According to this configuration, in a case where the user selects certain task information, the control apparatus receives the parameter according to the task of the robot indicated by the selected task information and displays the simulation result of the operation of the robot based on the received parameter onto the operational screen. Accordingly, the control apparatus can cause the user to easily perform input of the parameter according to the task performed by the robot based on the simulation result of the operation of the robot displayed on the operational screen.

In another aspect of the invention, the control apparatus may be configured such that the simulation is three-dimensional simulation.

According to this configuration, in a case where the user selects certain task information, the control apparatus receives the parameter according to the task of the robot indicated by the selected task information and displays a three-dimensional simulation result of operation of the robot based on the received parameter onto the operational screen. Accordingly, the control apparatus can cause the user to easily perform input of the parameter according to the task performed by the robot based on the three-dimensional simulation result of the operation of the robot displayed on the operational screen.

Still another aspect of the invention is directed to a robot that is controlled by the control apparatus described above.

According to this configuration, the robot can perform operation based on the parameter received by the control apparatus described above. Accordingly, the robot can accurately perform a task including operation desired by the user.

According to the above description, the control apparatus displays the operational screen, receives the parameter according to the task of the robot indicated by selected task information once the selection of the task information is received, and displays the information indicating the operation of the robot based on the received parameter onto the operational screen. Accordingly, the control apparatus can cause the user to easily perform input of the parameter according to the task performed by the robot.

In addition, the robot can perform operation based on the parameter received by the control apparatus described above. Accordingly, the robot can accurately perform the task including the operation desired by the user.

### BRIEF DESCRIPTION OF THE DRAWINGS

The invention will be described with reference to the accompanying drawings, wherein like numbers reference like elements.

FIG. 1 is a view illustrating an example of a configuration of a robot system according to the embodiment.

FIG. 2 is a diagram illustrating an example of a hardware configuration of an information processing device.

FIG. 3 is a diagram illustrating an example of a functional configuration of the information processing device.

FIG. 4 is a view illustrating an operational screen, which is an example of the operational screen.

FIG. 5 is a view illustrating an example of the operational screen.

FIG. 6 is a view illustrating an example of the operational screen.

FIG. 7 is a view illustrating an example of the operational screen after a tab is clicked by a user.

FIG. 8 is a view illustrating an example of the operational screen after the tab is clicked by the user.

FIG. 9 is a view illustrating an example of the operational screen after the tab is clicked by the user.

FIG. 10 is a flow chart illustrating an example of flow of processing of receiving a parameter according to a task that the information processing device causes a robot to perform from the operational screen.

FIG. 11 is a view illustrating an example of the operational screen displayed in a case where the user selects task information.

FIG. 12 is a view illustrating an example of the operational screen after a task start position, a task start orientation, an application force, a termination condition, and a parameter of force control in first stage force control are received.

### DESCRIPTION OF EXEMPLARY EMBODIMENTS

### Embodiment

Hereinafter, an embodiment of the invention will be described with reference to the drawings.

### Configuration of Robot System

First, a configuration of a robot system 1 will be described.

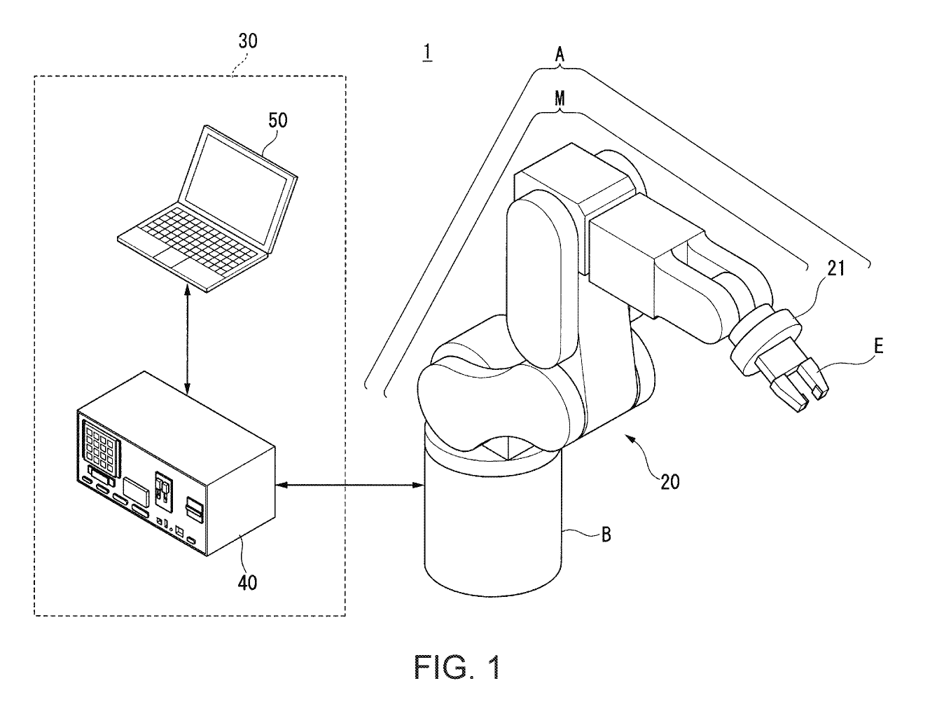

FIG. 1 is a view illustrating an example of the configuration of the robot system 1 according to the embodiment. The robot system 1 is provided with a robot 20 and a control apparatus 30. In addition, the control apparatus 30 is provided with a robot control device 40 and an information processing device 50. The robot control device 40 and the information processing device 50 configure the control apparatus 30 as separate elements in this example, but instead of this, the robot control device 40 and the information processing device 50 may integrally configure the control apparatus 30.

The robot 20 is an one-armed robot provided with an arm A and a support base B which supports the arm A. The one-armed robot is a robot provided with one arm such as the arm A in this example. Instead of the one-armed robot, the robot 20 may be a multi-armed robot. The multi-armed robot is a robot provided with two or more arms (for example, two or more arms A). Among multi-armed robots, the robot provided with two arms may also be referred to as a two-armed robot. That is, the robot 20 may be a two-armed robot provided with two arms or may be a multi-armed robot provided with three or more arms (for example, three or more arms A). In addition, the robot 20 may be a SCARA, a Cartesian robot, or other robots. The Cartesian robot is, for example, a gantry robot.

The arm A is provided with an end effector E, a manipulator M, and a force detecting unit 21.

The end effector E is an end effector provided with a finger portion capable of gripping an object in this example. Instead of the end effector provided with this finger portion, the end effector E may be an end effector capable of lifting up an object by means of air suction, a magnetic force, or a jig, or other end effectors.

The end effector E is connected by means of a cable such that the end effector E can communicate with the robot control device 40. Accordingly, the end effector E operates based on a control signal acquired from the robot control device 40. Wired communication via the cable is performed in accordance with standards, for example, Ethernet (registered trademark) and Universal Serial Bus (USB). In addition, the end effector E may be configured so as to be connected to the robot control device 40 by means of wireless communication conducted in accordance with communication standards such as Wi-Fi (registered trademark).

The manipulator M is provided with six joints. In addition, each of these six joints is provided with an actuator (not illustrated). That is, the arm A provided with the manipulator M is a six-axis vertically articulated arm. The arm A operates with six axes of freedom by cooperated operation of the support base B, the end effector E, the manipulator M, and actuators of each of the six joints provided in the manipulator M. The arm A may be configured so as to operate with five or less axes of freedom or may be configured so as to operate with seven or more axes of freedom.

Each of the six actuators (provided in the joints) provided in the manipulator M is connected by means of a cable such that the six actuators can communicate with the robot control device 40. Accordingly, the actuators cause the manipulator M to operate based on the control signal acquired from the robot control device 40. Wired communication via the cable is performed in accordance with standards, for example, Ethernet (registered trademark) and USB. In addition, a part or the whole of the six actuators provided in the manipulator M may be configured so as to be connected to the robot control device 40 by means of wireless communication conducted in accordance with communication standards such as Wi-Fi (registered trademark).

The force detecting unit 21 is provided between the end effector E and the manipulator M. The force detecting unit 21 is, for example, a force sensor. The force detecting unit 21 detects an external force applied to an object gripped by the end effector E or to the end effector E. The external force includes a translational force that translates the object gripped by the end effector E or the end effector E, and the rotational moment (torque) that rotates the object gripped by the end effector E or the end effector E. The force detecting unit 21 outputs force detection information that includes a value indicating the magnitude of the detected external force as an output value to the robot control device 40 through communication.

The force detection information is used in force control, which is control based on force detection information, out of types of control of the robot 20 carried out by the robot control device 40. The force control is control to operate at least one of the end effector E and the manipulator M such that the external force indicated by the force detection information realizes a state where a predetermined termination condition is satisfied. The termination condition is a condition for the robot control device 40 to terminate the operation of the robot 20 through the force control. That is, the force control is, for example, compliant motion control, including impedance control. The force detecting unit 21 may be other sensors that detect a value indicating the magnitude of a force or moment exerted to the object gripped by the end effector E or to the end effector E, such as a torque sensor. In addition, the force detecting unit 21 may be configured so as to be provided in other parts of the manipulator M, instead of a configuration of being provided between the end effector E and the manipulator M.

The force detecting unit 21 is connected by means of a cable such that the force detecting unit 21 can communicate with the robot control device 40. Wired communication via the cable is performed in accordance with standards, for example, Ethernet (registered trademark) and USB. The force detecting unit 21 and the robot control device 40 may be configured so as to be connected to each other by means of wireless communication conducted in accordance with communication standards such as Wi-Fi (registered trademark).

The robot control device 40 is a controller that controls a robot in this example. The robot control device 40 sets a control point T, which moves along with the end effector E, at a position correlated in advance with the end effector E. The position correlated in advance with the end effector E is a position in a robot coordinate system RC. The position correlated in advance with the end effector E is, for example, the position of the centroid of a target object O1 (not illustrated) gripped by the end effector E. The control point T is, for example, a tool center point (TCP). Instead of the TCP, the control point T may be other virtual points including a virtual point correlated with a part of the arm A. That is, the control point T may be configured so as to be set at positions of other parts of the end effector E or may be configured so as to be set at any positions correlated with the manipulator M, instead of the position of the centroid of the target object O1 gripped by the end effector E.

In the control point T, control point position information, which is information indicating the position of the control point T, is correlated with control point orientation information, which information indicating the orientation of the control point T. This position is a position in the robot coordinate system RC. This orientation is an orientation in the robot coordinate system RC. In addition to these types of information, the control point T may be configured such that other types of information are correlated with each other. Once the robot control device 40 designates (determines) control point position information and control point orientation information, the position and orientation of the control point T are determined. The position and the orientation are a position in the robot coordinate system RC and an orientation in the robot coordinate system RC. The robot control device 40 operates the arm A to match the position of the control point T to a position indicated by the control point position information designated by the robot control device 40 and to match the orientation of the control point T to an orientation indicated by the control point orientation information designated by the robot control device 40. Hereinafter, for convenience of description, description will be given with a position indicated by control point position information designated by the robot control device 40 being referred to as a target position and an orientation indicated by control point orientation information designated by the robot control device 40 being referred to as a target orientation. That is, the robot control device 40 operates the robot 20 and matches the position and orientation of the control point T to the target position and the target orientation, by designating the control point position information and the control point orientation information.

In this example, the position of the control point T is represented by a position in the robot coordinate system RC, which is the original of a control point coordinate system TC. In addition, the orientation of the control point T is represented by a direction in the robot coordinate system RC, which is each coordinate axis of the control point coordinate system TC. The control point coordinate system TC is a three-dimensional local coordinate system, which is correlated with the control point T so as to move along with the control point T. Herein, the position and orientation of the control point T represent the position and orientation of the target object O1 since the target object O1 moves along with the control point T in this example.

The robot control device 40 sets the control point T based on control point setting information input in advance by a user. The control point setting information is, for example, information that indicates a relative position and orientation between the position and orientation of the centroid of the end effector E and the position and orientation of the control point T. Instead of this information, the control point setting information may be information indicating a relative position and orientation between any position and orientation correlated with the end effector E and the position and orientation of the control point T, may be information indicating a relative position and orientation between any position and orientation correlated with the manipulator M and the position and orientation of the control point T, or may be information indicating a relative position and orientation between any position and orientation correlated with other parts of the robot 20 and the position and orientation of the control point T.

In addition, the robot control device 40 acquires teaching information from the information processing device 50. The robot control device 40 operates the robot 20 based on the acquired teaching information and causes the robot 20 to perform a task desired by the user. Hereinafter, a case where the task is a task of inserting the target object O1 (not illustrated) gripped in advance by the end effector E into a target object O2 (not illustrated), which is the target object O2 into which the target object O1 is inserted, will be described as an example. Instead of the above task, this task may be other tasks, such as a task of engaging a certain target object with another target object, with which this target object is engaged. The teaching information is information that includes parameter information indicating a parameter according to this task in this example. Hereinafter, a case where the parameter according to this task is a parameter of force control will be described as an example. The parameter of force control is an impedance parameter since the force control is impedance control in this example. That is, the parameter of force control includes each of parameters including a virtual inertia coefficient, a virtual viscosity coefficient, and a virtual elasticity coefficient. The parameter according to this task may be configured so as to include other parameters according to this task instead of a part or the whole of the above parameters, or may be configured so as to include other parameters according to this task in addition to a part or the whole of these parameters. In addition, hereinafter, a case where the teaching information is information that includes termination condition information indicating the aforementioned termination condition and teaching point information in addition to the parameter information will be described as an example. The teaching information may be configured so as to include other types of information in addition to this parameter information.

The teaching point information is information indicating each of one or more teaching points (points). The teaching point is a virtual point, to which a target for the control point T to move, when the robot control device 40 operates the manipulator M. In the teaching point, teaching point position information is correlated with teaching point orientation information. The teaching point position information is information indicating the position of the teaching point. In addition, the teaching point orientation information is information indicating the orientation of the teaching point. Teaching point identification information is information to identify a teaching point. In this example, the position of the teaching point is represented by a position in the robot coordinate system RC, which is the original of a teaching point coordinate system that is a three-dimensional local coordinate system correlated with the teaching point. In addition, the orientation of the teaching point is represented by a direction in the robot coordinate system RC, which is each coordinate axis of the teaching point coordinate system. In this example, in a case where a certain teaching point matches the control point T, the position and orientation of the control point T match the position and orientation of the teaching point.

Herein, the robot control device 40 designates control point position information and control point orientation information through position control based on teaching information acquired from the information processing device 50 and an operation program stored in advance and matches the position and orientation of the control point T to the target position and the target orientation. Accordingly, the robot control device 40 operates the robot 20 through the position control.

In the position control, the robot control device 40 specifies the position and orientation of the teaching point indicated by teaching point identification information designated by the operation program based on teaching point information included in the teaching information. The robot control device 40 designates information indicating the specified position of the teaching point as control point position information and designates information indicating the specified orientation of the teaching point as control point orientation information. Accordingly, the robot control device 40 matches the position and orientation of the control point T to the position and orientation of the teaching point, that is, a target position and a target orientation.

In addition, the robot control device 40 designates control point position information and control point orientation information through the force control based on the teaching point information acquired from the information processing device 50 and the force detection information acquired from the force detecting unit 21 and matches the position and orientation of the control point T to the target position and the target orientation. Accordingly, the robot control device 40 operates the robot 20 through the force control.

In the force control, based on the parameter information included in the teaching information acquired from the information processing device 50 and an external force indicated by the force detection information acquired from the force detecting unit 21, the robot control device 40 calculates the position and orientation of the control point T estimated to realize a state where the external force satisfies the termination condition indicated by the termination condition information included in the teaching information. The robot control device 40 designates information indicating this calculated position as control point position information and designates information indicating this calculated orientation as control point orientation information. Accordingly, the robot control device 40 matches the position and orientation of the control point T to the position and orientation, that is, the target position and the target orientation. In the force control, the robot control device 40 stops movement of the position and orientation of the control point T, that is, operation of the robot 20, in a case where a state where this external force satisfies the termination condition is realized.

By means of at least one of such position control and force control, the robot control device 40 causes the robot 20 to perform the aforementioned task desired by the user.

In addition, the robot control device 40 acquires instruction to operate the robot 20 from the information processing device 50. Based on information indicating operation of the robot 20 correlated with the acquired instruction, the robot control device 40 causes the robot 20 to perform this operation.

In addition, the robot control device 40 acquires instruction of force detection information acquisition from the information processing device 50. The robot control device 40 acquires force detection information from the force detecting unit 21 according the acquired instruction. Then, the robot control device 40 outputs the acquired force detection information to the information processing device 50.

The information processing device 50 is a work station, a desktop personal computer (PC), a laptop, a tablet PC, a multi-functional mobile terminal (smartphone), an electronic book reader with a communication function, or a personal digital assistant (PDA). Instead of these devices, the information processing device 50 may be a teaching device including a teaching pendant.

The information processing device 50 is connected by means of a cable such that the information processing device 50 can communicate with the robot control device 40. Wired communication via the cable is performed in accordance with standards, for example, Ethernet (registered trademark) and USB. In addition, the information processing device 50 may be configured so as to be connected to the robot control device 40 by means of wireless communication conducted in accordance with communication standards such as Wi-Fi (registered trademark).

The information processing device 50 generates the aforementioned teaching information based on operation received from the user. Specifically, the information processing device 50 receives a parameter according to a task that the robot control device 40 causes the robot 20 to perform (that is, a task desired by the user) based on operation received from the user. The information processing device 50 generates parameter information indicating the received parameter. In addition, the information processing device 50 receives a desired position and orientation, to which the user intends to match the position and orientation of the control point T, based on operation received from the user. The information processing device 50 generates teaching point information indicating a teaching point in which teaching point position information indicating the received position and teaching point orientation information indicating the received orientation are correlated with each other. In addition, the information processing device 50 receives the aforementioned termination condition based on operation received from the user. The information processing device 50 generates termination condition information indicating the received termination condition. Then, the information processing device 50 generates teaching information that includes each of the generated parameter information, teaching point information, and termination condition information. The information processing device 50 outputs the generated teaching information to the robot control device 40 and stores the information in the robot control device 40. That is, the information processing device 50 gives the robot control device 40 the teaching information.

In addition, the information processing device 50 outputs instruction to operate the robot 20 to the robot control device 40 based on operation received from the user. This instruction is correlated with information indicating operation of the robot 20.

In addition, the information processing device 50 outputs instruction of force detection information acquisition to the robot control device 40 based on operation received from the user. Then, the information processing device 50 acquires force detection information, which is acquired by the robot control device 40 from the force detecting unit 21, from the robot control device 40 as a response of this instruction.

### Outline of Processing Performed by Information Processing Device

Hereinafter, the outline of processing performed by the information processing device 50 will be described.

When receiving a parameter according to a task that the robot control device 40 causes the robot 20 to perform from the user, the information processing device 50 displays an operational screen, which is a screen on which task information indicating each of a plurality of tasks performed by the robot 20 provided with the force detecting unit 21 is displayed, receives a parameter according to a task of the robot 20 indicated by selected task information once task information is selected (in a case where certain task information is selected by the user), and displays information indicating operation of the robot 20 based on the received parameter onto the operational screen. Accordingly, the information processing device 50 (that is, the control apparatus 30) can exclude parameters not related to the task from a plurality of parameters and receive the parameter according to the task. As a result, the information processing device 50 can cause the user to easily perform input of a parameter according to a task performed by the robot 20. Hereinafter, this operational screen and processing of the information processing device 50 receiving a parameter will be described in detail. In addition, hereinafter, a case where information indicating operation of the robot 20 based on a parameter received by the information processing device 50 is a simulation result of the operation of the robot 20 based on the parameter received by the information processing device 50 will be described as an example. Instead of the above information, this information may be other types of information indicating this operation.

### Hardware Configuration of Information Processing Device

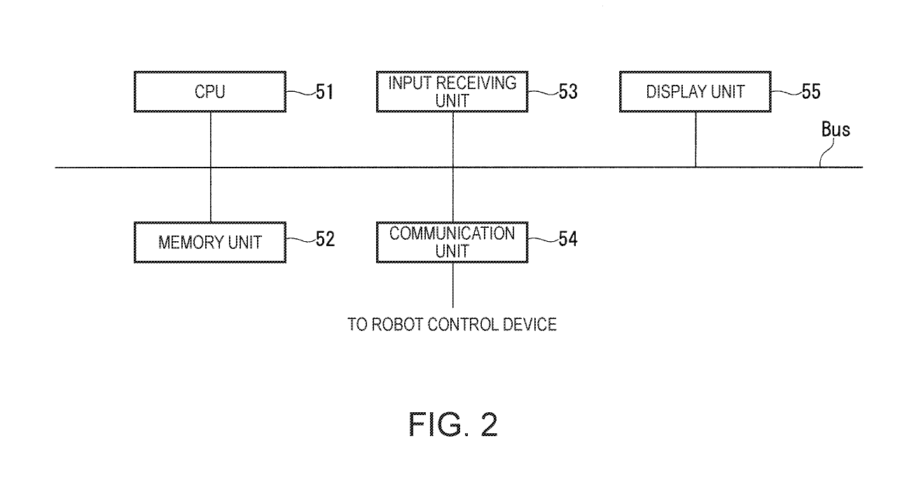

Hereinafter, a hardware configuration of the information processing device 50 will be described with reference to FIG. 2. FIG. 2 is a diagram illustrating an example of the hardware configuration of the information processing device 50.

The information processing device 50 is provided with, for example, a central processing unit (CPU) 51, a memory unit 52, an input receiving unit 53, a communication unit 54, and a display unit 55. These configuration elements are connected such that they can communicate with each other via a bus. In addition, the information processing device 50 communicates with the robot control device 40 via the communication unit 54.

The CPU 51 executes a variety of programs stored in the memory unit 52.

The memory unit 52 includes, for example, a hard disk drive (HDD) or a solid state drive (SSD), an electrically erasable programmable read-only memory (EEPROM), a read-only memory (ROM), and a random access memory (RAM). Instead of being mounted in the information processing device 50, the memory unit 52 may be an external type memory device connected by a digital input and output port such as a USB. The memory unit 52 stores a variety of types of information and images, which are processed by the information processing device 50, and a variety of programs.

The input receiving unit 53 is, for example, a touch panel configured so as to be integrated with the display unit 55. The input receiving unit 53 may be a keyboard or a mouse, a touchpad, and other input devices.

The communication unit 54 is configured so as to include, for example, a digital input and output port, such as a USB, and an Ethernet (registered trademark) port.

The display unit 55 is, for example, a liquid crystal display panel or an organic electroluminescent (EL) display panel.

### Functional Configuration of Information Processing Device

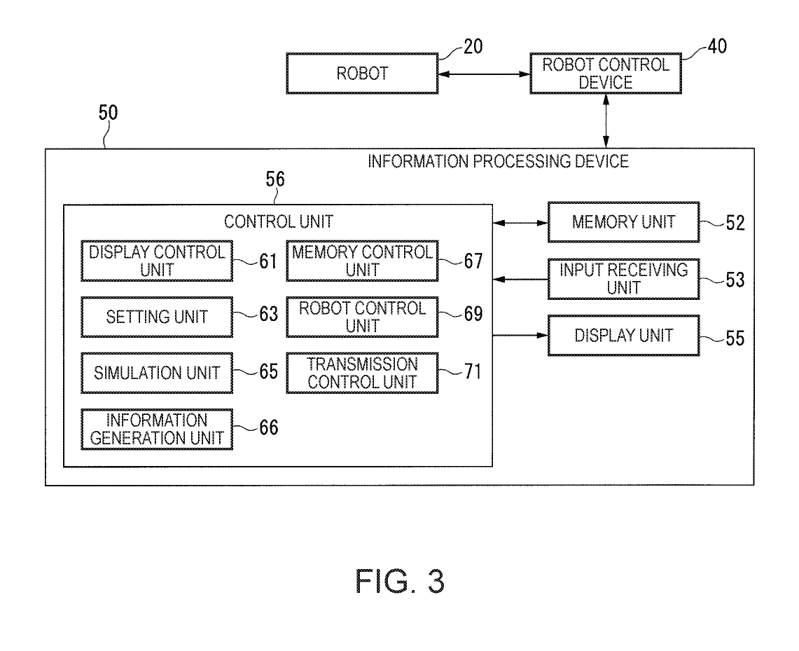

Hereinafter, a functional configuration of the information processing device 50 will be described with reference to FIG. 3. FIG. 3 is a diagram illustrating an example of the functional configuration of the information processing device 50.

The information processing device 50 is provided with the memory unit 52, the input receiving unit 53, the display unit 55, and a control unit 56.

The control unit 56 controls the entire information processing device 50. The control unit 56 is provided with a display control unit 61, a setting unit 63, a simulation unit 65, an information generation unit 66, a memory control unit 67, a robot control unit 69, and a transmission control unit 71. These functional units provided in the control unit 56 are realized, for example, by the CPU 51 executing a variety of programs stored in the memory unit 52. In addition, a part or the whole of the functional units may be a hardware functional unit such as large scale integration (LSI) and application specific integrated circuit (ASIC).

The display control unit 61 generates a variety of screens that include the aforementioned operational screen based on operation received from the user. The display control unit 61 causes the display unit 55 to display a variety of generated screens. In addition, the display control unit 61 causes a result of simulation performed by the simulation unit 65 to be displayed on the operational screen.

The setting unit 63 sets a parameter, which is received from the operational screen displayed by the display unit 55, in the simulation unit 65.

The simulation unit 65 performs simulation of operation of the robot 20 based on the parameter set by the setting unit 63.

Based on operation from the user, which is received from the operational screen displayed by the display unit 55, the information generation unit 66 generates parameter information indicating the parameter received from the operational screen displayed by the display unit 55. In addition, based on operation from the user, which is received from the operational screen displayed by the display unit 55, the information generation unit 66 generates teaching point position information and teaching point orientation information indicating a position and orientation received from the operational screen displayed by the display unit 55. The information generation unit 66 generates teaching point information indicating a teaching point in which the generated teaching point position information and teaching point orientation information are correlated with each other. In addition, based on operation from the user, which is received from the operational screen displayed by the display unit 55, the information generation unit 66 generates termination condition information indicating a termination condition received from the operational screen displayed by the display unit 55. In addition, the information generation unit 66 generates teaching information in which the teaching point information, the termination condition information, and the parameter information are correlated with one another.

The memory control unit 67 causes the memory unit 52 to store a variety of types of information including teaching information generated by the information generation unit 66.

The robot control unit 69 causes the real robot 20 to perform the same operation as the operation of the virtual robot 20 in simulation performed by the simulation unit 65. In addition, the robot control unit 69 outputs instruction to cause the robot 20 to perform operation, which is based on operation from the user received from the operational screen displayed by the display unit 55, to the robot control device 40 and causes the robot 20 to perform the operation. This instruction is instruction correlated with information indicating this operation.

The transmission control unit 71 outputs the teaching information generated by the information generation unit 66 to the robot control device 40 and stores the information in the robot control device 40.

### Specific Example of Operational Screen

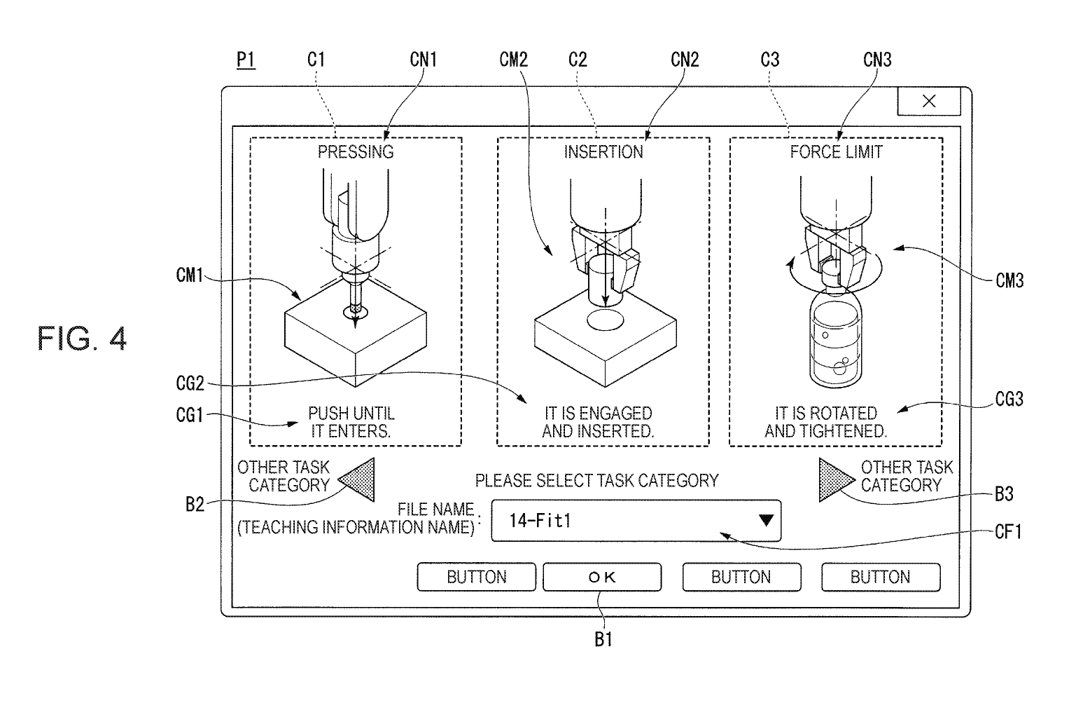

Hereinafter, the operational screen that the information processing device 50 causes the display unit 55 to display based on operation received from the user will be described with reference to FIG. 4 to FIG. 10. FIG. 4 is a view illustrating an operational screen P1, which is an example of the operational screen.

The operational screen P1 includes task category information C1, task category information C2, task category information C3, a plurality of buttons, including each of a button B1, a button B2, and a button B3, and a file name input field CF1, as graphical user interfaces (GUI). In addition to these GUIs, the operational screen P1 may be configured so as to include other GUIs. In addition, instead of a part or the whole of these GUIs, the operational screen P1 may be configured so as to include other GUIs.

The task category information C1 is one of pieces of task category information indicating each of one or more task categories into which tasks performed by the robot 20 are classified (correlated). In an example illustrated in FIG. 4, the task category information C1 is information indicating a task category into which tasks that include operation of the robot 20 pressing an object gripped by the robot 20 to another object through force control is classified. In addition, this task is a task that does not entail insertion or engagement of the object gripped by the robot 20 to or with another object.

In a case where the user clicks (taps) the task category information C1 (that is, once the selection of the task category information C1 is received), the display control unit 61 causes information indicating the selection of the task category information C1 to be displayed on the operational screen P1. For example, as the information indicating the selection, the display control unit 61 changes the color of the surroundings of the task category information C1 into a color different from the color of the surroundings of other task category information.

The task category information C1 includes a name CN1, an image CM1, and an explanatory text CG1. The task category information C1 may be configured so as to include other GUIs in addition to a part or the whole of these GUIs. In addition, the task category information C1 may be configured so as to include other GUIs instead of a part or the whole of these GUIs.

The name CN1 is the name of the task category indicated by the task category information C1. In the example illustrated in FIG. 4, the name CN1 is “pressing”.

The image CM1 is a still image or a moving image that shows operation common to tasks classified as the task category indicated by the task category information C1. This operation is operation of the robot 20. In the example illustrated in FIG. 4, the image CM1 is a moving image showing operation of the robot 20 pressing an object gripped by the robot 20 to another object.

The explanatory text CG1 is a sentence that describes what the operation common to tasks classified as the task category indicated by the task category information C1 is. In the example illustrated in FIG. 4, the explanatory text CG1 is “It is pushed until it enters.”.

The task category information C2 is information indicating a task category different from the task category indicated by the task category information C1. In the example illustrated in FIG. 4, the task category information C2 is information indicating a task category into which tasks that include operation of the robot 20 inserting an object gripped by the robot 20 into another object through force control is classified.

In a case where the user clicks (taps) the task category information C2 (that is, once the selection of the task category information C2 is received), the display control unit 61 causes information indicating the selection of the task category information C2 to be displayed on the operational screen P1. For example, as the information indicating the selection, the display control unit 61 changes the color of the surroundings of the task category information C2 into a color different from the color of the surroundings of other task category information.

The task category information C2 includes a name CN2, an image CM2, and an explanatory text CG2. The task category information C2 may be configured so as to include other GUIs in addition to a part or the whole of these GUIs. In addition, the task category information C2 may be configured so as to include other GUIs instead of a part or the whole of these GUIs.

The name CN2 is the name of the task category indicated by the task category information C2. In the example illustrated in FIG. 4, the name CN2 is “insertion”.

The image CM2 is a still image or a moving image that shows operation common to tasks classified as the task category indicated by the task category information C2. This operation is operation of the robot 20. In the example illustrated in FIG. 4, the image CM2 is a moving image showing operation of the robot 20 inserting an object gripped by the robot 20 into another object.

The explanatory text CG2 is a sentence that describes what the operation common to tasks classified as the task category indicated by the task category information C2 is. In the example illustrated in FIG. 4, the explanatory text CG2 is “It is engaged and inserted.”.

The task category information C3 is information indicating a task category different from the task categories, each of which are indicated by the task category information C1 and the task category information C2. In an example illustrated in FIG. 4, the task category information C3 is information indicating a task category that includes operation of the robot 20 tightening a lid (cap), which is gripped by the robot 20, to a main body of a PET bottle, to which the lid is tightened, through force control.

In a case where the user clicks (taps) the task category information C3 (that is, once the selection of the task category information C3 is received), the display control unit 61 causes information indicating the selection of the task category information C3 to be displayed on the operational screen P1. For example, as the information indicating the selection, the display control unit 61 changes the color of the surroundings of the task category information C3 into a color different from the color of the surroundings of other task category information.

The task category information C3 includes a name CN3, an image CM3, and an explanatory text CG3. The task category information C3 may be configured so as to include other GUIs in addition to a part or the whole of these GUIs. In addition, the task category information C3 may be configured so as to include other GUIs instead of a part or the whole of these GUIs.

The name CN3 is the name of the task category indicated by the task category information C3. In the example illustrated in FIG. 4, the name CN3 is “force limit”.

The image CM3 is a still image or a moving image that shows operation common to tasks classified as the task category indicated by the task category information C3. This operation is operation of the robot 20. In an example illustrated in FIG. 4, the image CM3 is an image showing operation of the robot 20 tightening a lid (cap), which is gripped by the robot 20, to a main body of a PET bottle, to which the lid is tightened, through force control.

The explanatory text CG3 is a sentence that describes what the operation common to tasks classified as the task category indicated by the task category information C3 is. In the example illustrated in FIG. 4, the explanatory text CG3 is “It is rotated and tightened.”.

When these task category information pieces are to be displayed by the display control unit 61, the display control unit 61 reads task category information stored in advance in the memory unit 52. Then, the display control unit 61 causes the read task category information to be displayed on the operational screen P1. At least a part of the task category information may be configured so as to be stored by the user in the memory unit 52 afterwards. In this case, the control unit 56 is provided with a generation unit that generates task category information according to operation received from the user. Then, the memory control unit 67 stores the task category information generated by this generation unit in the memory unit 52. In addition, each of contents (name, image, and explanatory text included in task category information) of task category information may be configured such that the user can perform editing, such as addition, modification, and deletion, afterwards. In this case, the control unit 56 is provided with an editing unit that edits task category information according to operation received from the user. Then, the memory control unit 67 stores the task category information edited by this editing unit in the memory unit 52.

The button B2 and the button B3 are buttons to change task category information (in this example, the task category information C1 to the task category information C3) displayed on the operational screen P1 into other types of task category information. Hereinafter, a case where order is correlated with task category information will be described as an example.

Specifically, the button B2 is a button to delete each of the task category information C1 to the task category information C3 from the operational screen P1 and to display task category information correlated with order, which comes before the task category information C1, onto the operational screen P1. In a case where the user clicks (taps) the button B2 (that is, once the selection of the button B2 is received), the display control unit 61 deletes each of the task category information C1 to the task category information C3 from the operational screen P1 and displays task category information correlated with order, which comes before the task category information C1, onto the operational screen P1.

The button B3 is a button to delete each of the task category information C1 to the task category information C3 from the operational screen P1 and to display task category information correlated with order, which comes after the task category information C1, onto the operational screen P1. In a case where the user clicks (taps) the button B3 (that is, once the selection of the button B3 is received), the display control unit 61 deletes each of the task category information C1 to the task category information C3 from the operational screen P1 and displays task category information correlated with order, which comes after the task category information C3, onto the operational screen P1.

The file name input field CF1 is a field into which the user inputs a file name (teaching information name) indicating teaching information in a case where the teaching information generated by the information processing device 50 is to be stored in the memory unit 52. In addition, in the example illustrated in FIG. 4, the file name input field CF1 is a pull-down menu and can display a list of file names indicating teaching information pieces stored in the memory unit 52.

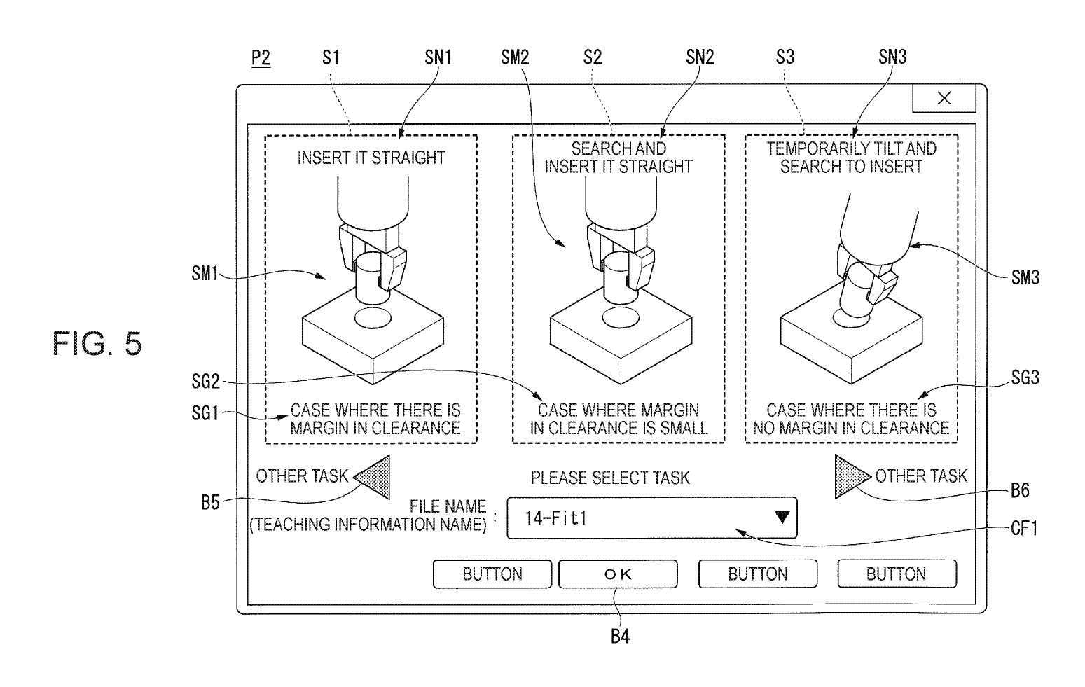

The button B1 is a button for the user to confirm selection of task category information on the operational screen P1. In a case where the user clicks (taps) the button B1 (that is, once the selection of the button B1 is received), the display control unit 61 specifies that task category information selected by the user on the operational screen P1 is task category information desired by the user. Then, the display control unit 61 transitions the operational screen P1 to an operational screen P2 illustrated in FIG. 5. FIG. 5 is a view illustrating an example of the operational screen P2. The operational screen P2 is a screen on which at least a part of information included in the operational screen P1 is altered into other type of information by the display control unit 61.

In this example, since a task desired by the user is a task of inserting the target object O1 (not illustrated) gripped in advance by the end effector E into the target object O2 (not illustrated), which is the target object O2 into which the target object O1 is inserted, hereinafter, a case where task category information selected by the user on the operational screen P1 illustrated in FIG. 4 is the task category information C2 will be described.

The operational screen P2 includes task information S1, task information S2, task information S3, a plurality of buttons including each of the button B1, a button B4, and a button B5, and the file name input field CF1 as GUIs. In addition to these GUIs, the operational screen P2 may be configured so as to include other GUIs. In addition, instead of a part or the whole of these GUIs, the operational screen P2 may be configured so as to include other GUIs.

The task information S1 is one of pieces of task information indicating each of one or more tasks classified as the task category information C2 (that is, one or more pieces of task information correlated with the task category information C2). In an example illustrated in FIG. 5, the task information S1 is information indicating a first task, which is a task of the robot 20 moving an insertion object, which is an object gripped by the robot 20, in an insertion direction and the robot 20 inserting the insertion object into an insertion portion, into which the insertion object is to be inserted, through force control. This insertion portion is a part formed into an insertion target object, which is an object into which is the insertion object is inserted. In addition, the insertion direction is a direction opposite to a direction of removing the insertion object from the insertion target object in a state where the insertion object is inserted into the insertion portion. In addition, the first task is a task in a case where the size of the insertion portion is larger than a surface on an insertion direction side out of surfaces of the insertion object, when the insertion portion is seen toward the insertion direction. That is, the first task is a task in a case where there is a clearance, which is equal to or larger than a first predetermined value, between the insertion object and the insertion portion when the insertion object is inserted into the insertion portion. Accordingly, in the first task, in a case of being moved straight toward the insertion direction, the insertion object is inserted into the insertion portion without coming into contact with parts other than the insertion portion, out of parts of the insertion target object.

In a case where the user clicks (taps) the task information S1 (that is, once the selection of the task information S1 is received), the display control unit 61 causes information indicating the selection of the task information S1 to be displayed on the operational screen P2. For example, as the information indicating the selection, the display control unit 61 changes the color of the surroundings of the task information S1 into a color different from the color of the surroundings of other task information.

The task information S1 includes a name SN1, an image SM1, and an explanatory text SG1. The task information S1 may be configured so as to include other GUIs in addition to a part or the whole of these GUIs. In addition, the task information S1 may be configured so as to include other GUIs instead of a part or the whole of these GUIs.

The name SN1 is the name of a task indicated by the task information S1. In the example illustrated in FIG. 5, the name SN1 is “insert it straight”.

The image SM1 is a still image or a moving image showing a task indicated by the task information S1. In the example illustrated in FIG. 5, the image SM1 is a moving image showing the aforementioned first task.

The explanatory text SG1 is a sentence that describes what the task indicated by the task information S1 is. In the example illustrated in FIG. 5, the explanatory text SG1 is “a case where there is a margin in the clearance”.

The task information S2 is information indicating a task different from the task indicated by the task information S1. In the example illustrated in FIG. 5, the task information S2 is information indicating a second task, which is a task of the robot 20 moving the aforementioned insertion object in the insertion direction and the robot 20 inserting the insertion object into the aforementioned insertion portion through force control. In addition, the second task is a task in a case where the size of the insertion portion is a size slightly larger than the surface on the insertion direction side out of the surfaces of the insertion object, when the insertion portion is seen toward the insertion direction. That is, the second task is a task in a case where there is a clearance, which is equal to or larger than a second predetermined value and is smaller than the first predetermined value, between the insertion object and the insertion portion (the margin in the clearance therebetween is small) when the insertion object is inserted in the insertion portion. That is, in the second task, in some cases, the insertion object comes into contact with parts other than the insertion portion out of parts of the insertion target object. For this reason, in the second task, the robot 20 performs searching operation of moving the insertion object in the insertion direction while searching for the insertion portion through force control and inserts the insertion object into the insertion portion. A method for causing the robot 20 to perform the second task through force control may be a known method or may be a method to be developed from now on.

In a case where the user clicks (taps) the task information S2 (that is, once the selection of the task information S2 is received), the display control unit 61 causes information indicating the selection of the task information S2 to be displayed on the operational screen P2. For example, as the information indicating the selection, the display control unit 61 changes the color of the surroundings of the task information S2 into a color different from the color of the surroundings of other task information.

The task information S2 includes a name SN2, an image SM2, and an explanatory text SG2. The task information S2 may be configured so as to include other GUIs in addition to a part or the whole of these GUIs. In addition, the task information S2 may be configured so as to include other GUIs instead of a part or the whole of these GUIs.

The name SN2 is the name of a task indicated by the task information S2. In the example illustrated in FIG. 5, the name SN2 is “search and insert it straight”.

The image SM2 is a still image or a moving image showing a task indicated by the task information S2. In the example illustrated in FIG. 5, the image SM2 is a moving image showing the aforementioned second task.

The explanatory text SG2 is a sentence that describes what the task indicated by the task information S2 is. In the example illustrated in FIG. 5, the explanatory text SG2 is “a case where the margin in the clearance is small”.

The task information S3 is information indicating a task different from the tasks, each of which are indicated by the task information S1 and the task information S2. In the example illustrated in FIG. 5, the task information S3 is information indicating a third task, which is a task of the robot 20 moving the aforementioned insertion object in the insertion direction and the robot 20 inserting the insertion object into the aforementioned insertion portion through force control. In addition, the third task is a task in a case where the size of the insertion portion is a size almost the same as that of a surface on the insertion direction side out of the surfaces of the insertion object, when the insertion portion is seen toward the insertion direction. That is, the third task is a task in a case where there is almost no clearance between the insertion object and the insertion portion (no margin in the clearance therebetween) when the insertion object is inserted in the insertion portion. That is, in the third task, in some cases, the insertion object comes into contact with parts other than the insertion portion out of parts of the insertion target object. In addition, in the third task, in some cases, time required for searching for the insertion portion through force control becomes longer since there is almost no clearance. For this reason, in the third task, the robot 20 inserts the insertion object into the insertion portion while changing the orientation of the insertion object through force control after a part of the insertion object is inserted in the insertion portion by tilting the insertion object with respect to the insertion target object while moving the insertion object in the insertion direction. A method for causing the robot 20 to perform the third task through force control may be a known method or may be a method to be developed from now on.

In a case where the user clicks (taps) the task information S3 (that is, once the selection of the task information S3 is received), the display control unit 61 causes information indicating the selection of the task information S3 to be displayed on the operational screen P2. For example, as the information indicating the selection, the display control unit 61 changes the color of the surroundings of the task information S3 into a color different from the color of the surroundings of other task information.

The task information S3 includes a name SN3, an image SM3, and an explanatory text SG3. The task information S3 may be configured so as to include other GUIs in addition to a part or the whole of these GUIs. In addition, the task information S3 may be configured so as to include other GUIs instead of a part or the whole of these GUIs.

The name SN3 is the name of a task indicated by the task information S3. In the example illustrated in FIG. 5, the name SN3 is “temporarily tilt and search to insert”.

The image SM3 is a still image or a moving image showing a task indicated by the task information S3. In the example illustrated in FIG. 5, the image SM3 is a moving image showing the aforementioned third task.

The explanatory text SG3 is a sentence that describes what the task indicated by the task information S3 is. In the example illustrated in FIG. 5, the explanatory text SG3 is “a case where there is no margin in the clearance”.

When these task information pieces are to be displayed by the display control unit 61, the display control unit 61 reads task information stored in advance in the memory unit 52. Then, the display control unit 61 causes the read task information to be displayed onto the operational screen P2. At least a part of the task information may be configured so as to be stored by the user in the memory unit 52 afterwards. In this case, the control unit 56 is provided with a generation unit that generates task information according to operation received from the user. Then, the memory control unit 67 correlates the task information generated by the generation unit with task category information according to the operation received from the user and stores the information in the memory unit 52. In addition, each of contents (name, image, and explanatory text included in task information) of task information may be configured such that the user can perform editing, such as addition, modification, and deletion, afterwards. In this case, the control unit 56 is provided with an editing unit that edits task information according to operation received from the user. Then, the memory control unit 67 stores the task information edited by this editing unit in the memory unit 52.

The button B5 and a button B6 are buttons to change task information (in this example, the task information S1 to the task information S3) displayed on the operational screen P2 into other types of task information. Hereinafter, a case where order is correlated with task information will be described as an example.

Specifically, the button B5 is a button to delete each of the task information S1 to the task information S3 from the operational screen P2 and to display task information correlated with order, which comes before the task information S1, onto the operational screen P2. In a case where the user clicks (taps) the button B5 (that is, once the selection of the button B5 is received), the display control unit 61 deletes each of the task information S1 to the task information S3 from the operational screen P2 and displays task information correlated with order, which comes before the task information S1, onto the operational screen P2.

The button B6 is a button to delete each of the task information S1 to the task information S3 from the operational screen P2 and to display task information correlated with order, which comes after the task information S1, onto the operational screen P2. In a case where the user clicks (taps) the button B6 (that is, once the selection of the button B6 is received), the display control unit 61 deletes each of the task information S1 to the task information S3 from the operational screen P2 and displays task information correlated with order, which comes after the task information S3, onto the operational screen P2.

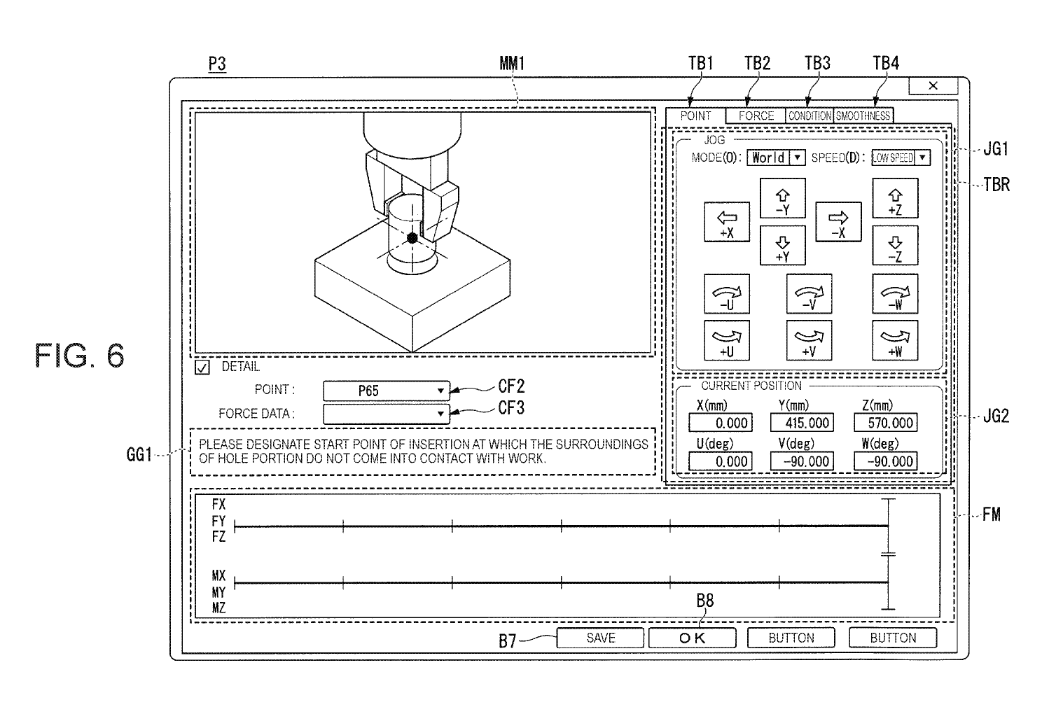

The button B4 is a button for the user to confirm selection of task information on the operational screen P2. In a case where the user clicks (taps) the button B4 (that is, once the selection of the button B4 is received), the display control unit 61 specifies that task information selected by the user on the operational screen P2 is task information desired by the user. Then, the display control unit 61 transitions the operational screen P2 to an operational screen P3 illustrated in FIG. 6. FIG. 6 is a view illustrating an example of the operational screen P3. The operational screen P3 is a screen on which at least a part of information included in the operational screen P2 is altered into other type of information by the display control unit 61.

In this example, since a task desired by the user is a task of inserting the target object O1 (not illustrated) gripped in advance by the end effector E into the target object O2 (not illustrated), which is the target object O2 into which the target object O1 is inserted, hereinafter, a case where task information selected by the user on the operational screen P2 illustrated in FIG. 5 is the task information S2 will be described.

The operational screen P3 is a screen that receives a parameter according to a task selected by the user on the operational screen P2 illustrated in FIG. 5, a desired position and orientation to which the user intends to match the position and orientation of the control point T, and the aforementioned termination condition. The operational screen P3 includes each of a tab TB1 to a tab TB4, a region TBR, a region MM1, a region FM, a region GG1, a file name input field CF2, a file name input field CF3, a plurality of buttons, including each of a button B7 and a button B8 as GUIs. In addition to these GUIs, the operational screen P3 may be configured so as to include other GUIs. In addition, instead of apart or the whole of these GUIs, the operational screen P3 may be configured so as to include other GUIs.

Each of the tab TB1 to the tab TB4 is a tab to switch between a GUI displayed in the region TBR and a GUI according to each of the tabs. In a case where the user clicks (taps) any one of the tab TB1 to the tab TB4, the display control unit 61 switches between the GUI displayed in the region TBR and a GUI according to a tab clicked (tapped) by the user. In addition, in this case, the display control unit 61 displays an explanatory text according to this tab in the region GG1. That is, the region GG1 is a region in which this explanatory text is displayed. In addition, in this case, the display control unit 61 displays an image according to this tab in the region MM1. That is, the region MM1 is a region in which this image is displayed. This image may be a still image or may be a moving image. There are four tabs, including the tab TB1 to the tab TB4, in the example illustrated in FIG. 6 to FIG. 9 but these tabs may be three or less tabs or may be five or more tabs.

The tab TB1 is a tab to display a GUI that receives a task start position and a task start orientation in the region TBR as a desired position and orientation to which the user intends to match the position and orientation of the control point T. The task start position is a desired position to which the user intends to match the position of the control point T when starting a task selected by the user in Step S110. The task start orientation is a position where a desired orientation, to which the user intends to match the orientation of the control point T, matches the orientation of the control point T when starting this task.

In a case where the user clicks (taps) the tab TB1 (that is, once the selection of the tab TB1 is received), the display control unit 61 displays, for example, each of a jog key JG1 and a region JG2 illustrated in FIG. 6 in the region TBR. That is, the region TBR is a region in which a GUI according to a tab clicked by the user is displayed. In addition, the operational screen P3 illustrated in FIG. 6 is an example of the operational screen P3 in a case where the user clicks (taps) the tab TB1. In this case, the display control unit 61 may be configured so as to display other GUIs in the region TBR in addition to any one of or both of the jog key JG1 and the region JG2. In addition, in this case, the display control unit 61 may be configured so as to display other GUIs in the region TBR instead of any one of or both of the jog key JG1 and the region JG2.

The jog key JG1 is a software key to operate the robot 20 based on operation received from the user (that is, jog operation). In a case where the user operates the jog key JG1, the robot control unit 69 changes the position and orientation of the control point T of the robot 20 according to the operation from the user. That is, the robot control unit 69 outputs instruction to cause the robot 20 to perform operation according to the operation from the user to the robot control device 40. As a result, the robot control device 40 causes the robot 20 to perform this operation based on this instruction acquired from the information processing device 50. Accordingly, the user can match the position and orientation of the control point T to a desired position and orientation, that is, the task start position and the task start orientation by operating the jog key JG1. In this example, the task start position is a position separated at a predetermined distance in the insertion direction apart from the bottom surface of an insertion portion O21, which is an insertion portion formed in the target object O2 and into which the target object O1 is inserted. The predetermined distance may be any distance insofar as the entire target object O1 is not included in the insertion portion O21 in a case where the position of the target object O1 (that is, the control point T) matches the task start position. In addition, the task start orientation is the orientation of the target object O1 in a state where the target object O1 is inserted in the insertion portion O21.

In addition, in a case where the user clicks (taps) the tab TB1, the display control unit 61 displays an explanatory text according to the tab TB1 in the region GG1. In the example illustrated in FIG. 6, the explanatory text displayed by the display control unit 61 in the region GG1 is “Please designate a start point of insertion at which the surroundings of a hole portion do not come into contact with a work.”.

In addition, in a case where the user clicks (taps) the tab TB1, the display control unit 61 displays an image according to the tab TB1 in the region MM1. In the example illustrated in FIG. 6, the image displayed by the display control unit 61 in the region MM1 is a three-dimensional still image showing the state of the target object O1 gripped by the end effector E and the target object O2, which is before the target object O1 is inserted, in a state where the position and orientation of the target object O1 (that is, the control point T) matches the task start position and the task start orientation.

The region JG2 is a region to display the position and orientation of the control point T moved based on operation from the user, which is received from the jog key JG1. In the example illustrated in FIG. 6, each of the X-axis coordinate, Y-axis coordinate, Z-axis coordinate, U-axis coordinate, V-axis coordinate, and W-axis coordinate of this control point T in the robot coordinate system RC is displayed in the region JG2. The U-axis coordinate is the coordinate of the U-axis, which is a coordinate axis representing a direction and pivot angle (that is, a coordinate) in which and at which pivoting around the X-axis of the control point coordinate system TC is carried out. The V-axis coordinate is the coordinate of the V-axis, which is a coordinate axis representing a direction and pivot angle (that is, a coordinate) in which and at which pivoting around the Y-axis of the control point coordinate system TC is carried out. The W-axis coordinate is the coordinate of the W-axis, which is a coordinate axis representing a direction and pivot angle (that is, a coordinate) in which and at which pivoting around the Z-axis of the control point coordinate system TC is carried out.

The tab TB2 is a tab to display a GUI that receives each of a force and the rotational moment, which are applied to the target object O1 by the robot 20, in the region TBR when inserting the target object O1 into the insertion portion O21 in a task indicated by task information selected by the user on the operational screen P2 illustrated in FIG. 5. Hereinafter, for convenience of description, description will be given with the force and the rotational moment being collectively referred to as an application force.

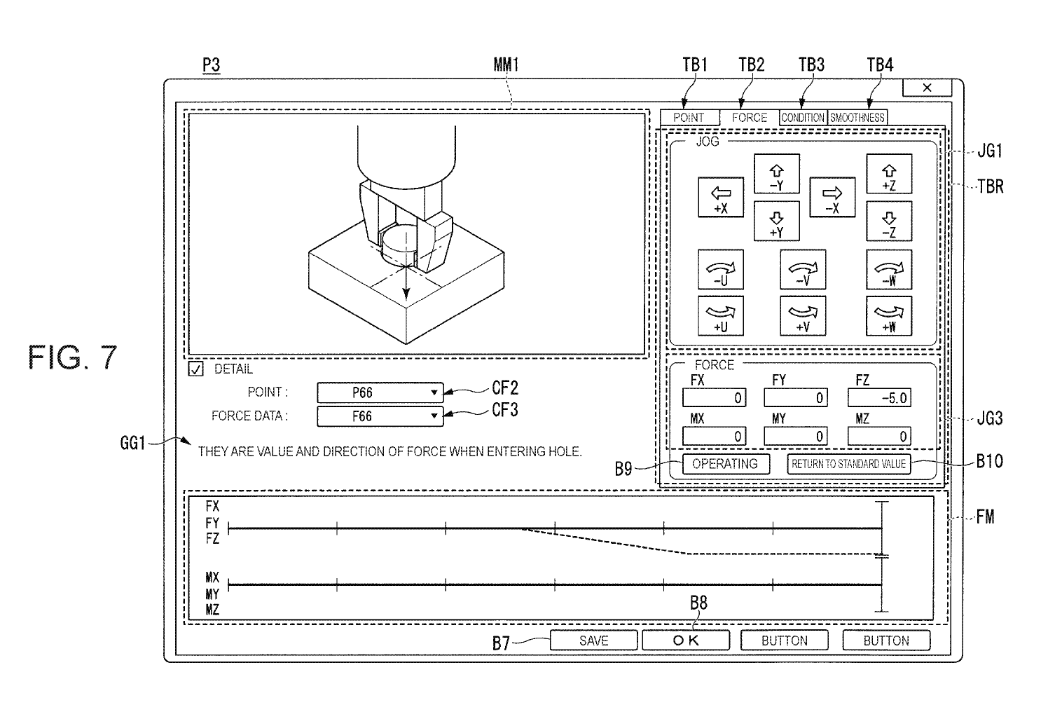

In a case where the user clicks (taps) the tab TB2 (that is, once the selection of the tab TB2 is received), the display control unit 61 transitions the operational screen P3 illustrated in FIG. 6 to the operational screen P3 illustrated in FIG. 7. FIG. 7 is a view illustrating an example of the operational screen P3 after the tab TB2 is clicked by the user.

On the operational screen P3 illustrated in FIG. 7, each of the jog key JG1, a region JG3, a button B9, and a button B10 is displayed in the region TBR. The display control unit 61 displays each of the jog key JG1, the region JG3, the button B9, and the button B10 in the region TBR in a case where the user clicks (taps) the tab TB2. In addition to these GUIs, the operational screen P3 may be configured so as to display other GUIs in the region TBR. In addition, instead of a part or the whole of these GUIs, the operational screen P3 may be configured so as to include other GUIs in the region TBR.

The region JG3 is a region to display a plurality of input fields, into which each of application forces to be applied by the robot 20 to the target object O1 is input by the user, when inserting the target object O1 into the insertion portion O21 in the task indicated by the task information selected by the user on the operational screen P2 illustrated in FIG. 5. The user can input each of the application forces by means of the input fields. In addition, in each of the input fields, a default value according to an application force to be input into each of the input fields is input in a case where a value is not input by the user. That is, the display control unit 61 displays the input fields, in which the default values are input, in a case where the region JG3 is displayed on the operational screen P3.

In addition, in a case where the user clicks (taps) the tab TB2, the display control unit 61 displays an explanatory text according to the tab TB2 in the region GG1. In the example illustrated in FIG. 7, the explanatory text displayed by the display control unit 61 in the region GG1 is “They are the value and direction of a force when entering a hole.”.

The button B9 is a button to operate the robot 20 and to cause the robot 20 to perform operation of applying an application force, which is input in the input field of the region JG3, to the target object O1. In a case where the user clicks (taps) the button B9 (that is, once the selection of the button B9 is received), the robot control unit 69 operates the robot 20 and causes the robot 20 to perform the operation of applying the application force, which is input in the input field of the region JG3, to the target object O1. In this case, the display control unit 61 outputs instruction of force detection information acquisition to the robot control device 40 each time a predetermined time has elapsed. The predetermined time is, for example, 0.1 seconds. Instead of 0.1 seconds, the predetermined time may be other time. The display control unit 61 acquires force detection information as a response of this instruction from the robot control device 40. The display control unit 61 displays, in the region FM, a graph showing time changes of each of external forces indicated by the acquired force detection information. That is, the region FM is a region to display this graph. Accordingly, for example, in a case where the user clicks (taps) the button B9, which is a case where the target object O1 is fixed so as not to move, it can be checked whether or not the robot 20 applies the application force, which is input in the input field of the region JG3, to the target object O1. This graph is an example of information based on an output value from a force detecting unit.

The button B10 is a button to delete all of values input by the user in each of the input fields of the region JG3 and to input default values according to application forces, which are to be input into each of the input fields, into each of the input fields. In a case where the user clicks (taps) the button B10 (that is, once the selection of the button B10 is received), the display control unit 61 deletes all of the values input by the user in each of the input fields and inputs default values according to application forces, which are to be input into each of the input fields, into each of the input fields.

In addition, on the operational screen P3 illustrated in FIG. 7, an image according to the tab TB2 is displayed in the region MM1. In a case where the user clicks (taps) the tab TB2, the display control unit 61 displays the image according to the tab TB2 instead of the image which has been displayed in the region MM1 until then. In the example illustrated in FIG. 7, in the region MM1, an image showing a state where the target object O1 is inserted into the insertion portion O21 is displayed as the image according to the tab TB2.

The tab TB3 is a tab to display a GUI that receives a termination condition to terminate operation of the robot 20 through force control in the region TBR in the task indicated by the task information selected by the user on the operational screen P2 illustrated in FIG. 5. Herein, the termination condition is represented by a desired external force intended to be applied to the target object O1 at a time of termination of this task, which is each external force detected by the force detecting unit 21.

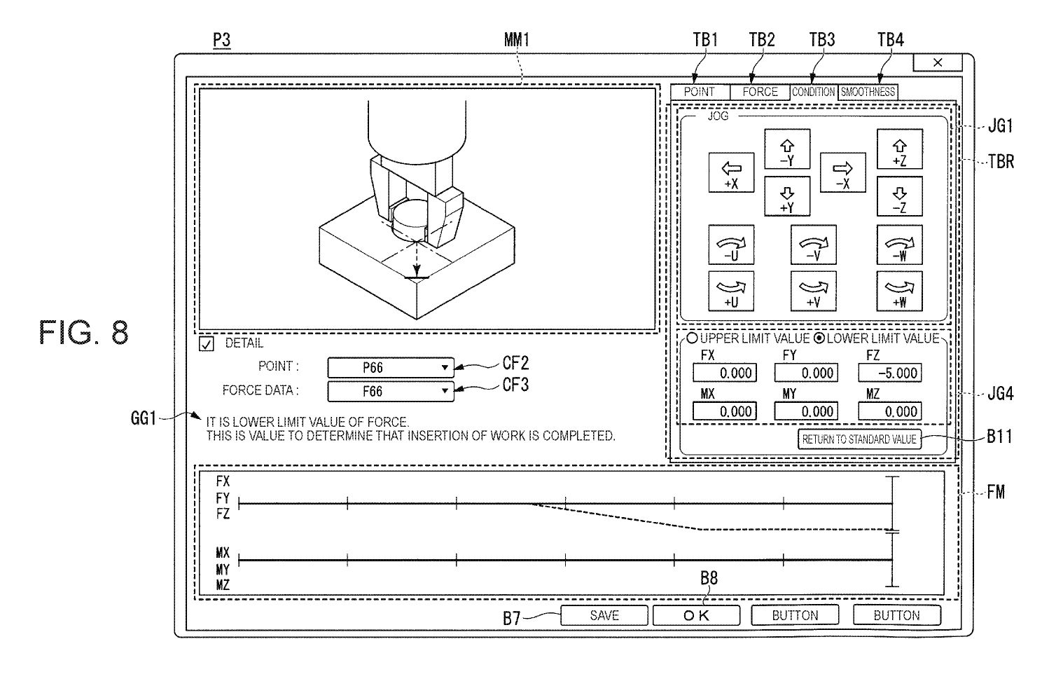

In a case where the user clicks (taps) the tab TB3 (that is, once the selection of the tab TB3 is received), the display control unit 61 transitions the operational screen P3 illustrated in FIG. 7 to the operational screen P3 illustrated in FIG. 8. FIG. 8 is a view illustrating an example of the operational screen P3 after the tab TB3 is clicked by the user.

On the operational screen P3 illustrated in FIG. 8, each of the jog key JG1, a region JG4, and a button B11 is displayed in the region TBR. The display control unit 61 displays each of the jog key JG1, the region JG4, and the button B11 in the region TBR in a case where the user clicks (taps) the tab TB3. In addition to these GUIs, the operational screen P3 may be configured so as to display other GUIs in the region TBR. In addition, instead of a part or the whole of these GUIs, the operational screen P3 may be configured so as to include other GUIs in the region TBR.

The region JG4 is a region to display a plurality of input fields, into which each of external forces representing a termination condition to terminate operation of the robot 20 through force control are input by the user, in the task indicated by the task information selected by the user on the operational screen P2 illustrated in FIG. 5. The user can input each of the external forces by means of the input fields. In addition, in each of the input fields, a default value according to each of the external forces to be input into each of the input fields is input in a case where a value is not input by the user. That is, the display control unit 61 displays the input fields, in which the default values are input, in a case where the region JG4 is displayed on the operational screen P3.

In addition, in a case where the user clicks (taps) the tab TB3, the display control unit 61 displays an explanatory text according to the tab TB3 in the region GG1. In the example illustrated in FIG. 8, the explanatory text displayed by the display control unit 61 in the region GG1 is “It is a lower limit value of a force. This is a value to determine that insertion of a work is completed.”.

The button B11 is a button to delete all of values input by the user in each of the input fields of the region JG4 and to input default values according to external forces, which are to be input into each of the input fields, into each of the input fields. In a case where the user clicks (taps) the button B11 (that is, once the selection of the button B11 is received), the display control unit 61 deletes all of the values input by the user in each of the input fields and inputs default values according to external forces, which are to be input into each of the input fields, into each of the input fields.

In addition, on the operational screen P3 illustrated in FIG. 8, an image according to the tab TB3 is displayed in the region MM1. In a case where the user clicks (taps) the tab TB3, the display control unit 61 displays the image according to the tab TB3 instead of the image which has been displayed in the region MM1 until then. In the example illustrated in FIG. 8, in the region MM1, an image showing a state where the target object O1 is inserted into the insertion portion O21 is displayed as the image according to the tab TB3. In this example, the image displayed in the region MM1 illustrated in FIG. 8 and the image displayed in the region MM1 illustrated in FIG. 7 are the same image but may be different images.

The tab TB4 is a tab to display a GUI that receives a parameter of force control in the region TBR in the task indicated by task information selected by the user on the operational screen P2 illustrated in FIG. 5. Herein, the parameter is an impedance parameter since the force control is impedance control in this example. That is, the parameter is each of a virtual inertia coefficient, a virtual viscosity coefficient, and a virtual elasticity coefficient. The movement of the robot 20 through the force control is determined by these impedance parameters.

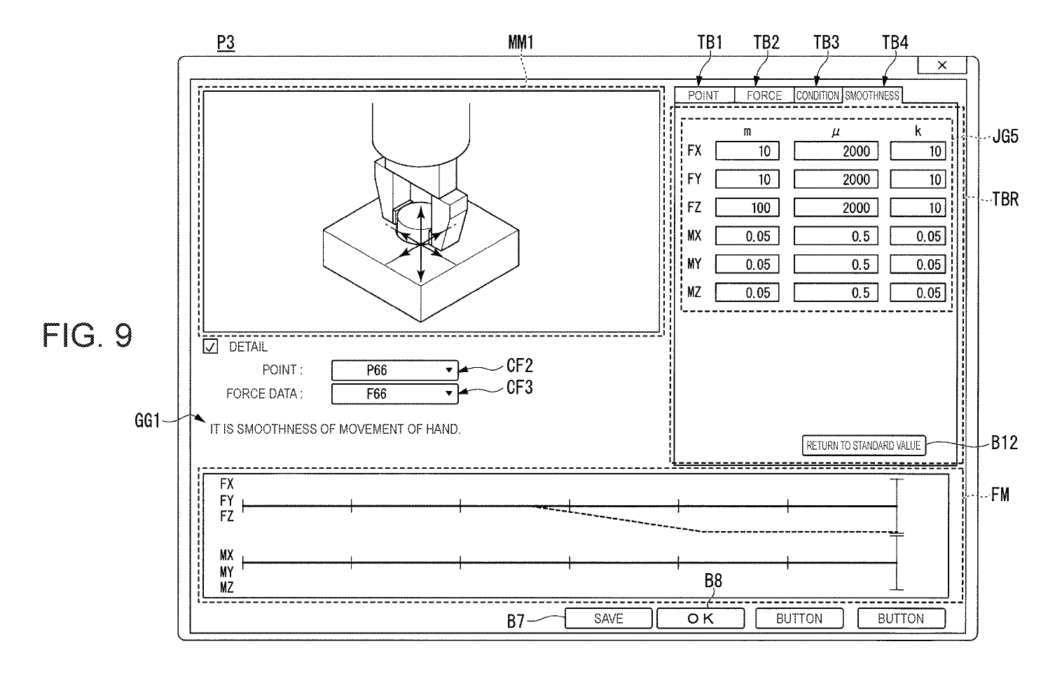

In a case where the user clicks (taps) the tab TB4 (that is, once the selection of the tab TB4 is received), the display control unit 61 transitions the operational screen P3 illustrated in FIG. 8 to the operational screen P3 illustrated in FIG. 9. FIG. 9 is a view illustrating an example of the operational screen P3 after the tab TB3 is clicked by the user.

On the operational screen P3 illustrated in FIG. 9, each of a region JG5 and a button B12 is displayed in the region TBR. The display control unit 61 displays each of the region JG5 and the button B12 in the region TBR in a case where the user clicks (taps) the tab TB4. In addition to these GUIs, the operational screen P3 may be configured so as to display other GUIs in the region TBR. In addition, instead of a part or the whole of these GUIs, the operational screen P3 may be configured so as to include other GUIs in the region TBR.

In the task indicated by the task information selected by the user on the operational screen P2 illustrated in FIG. 5, the region JG5 is a region to display a plurality of input fields, into which each of parameters according to the task (in this example, parameters of force control) is input by the user. The user can input each of the parameters by means of the input fields. In addition, in each of the input fields, a default value according to a parameter to be input into each of the input fields is input in a case where a value is not input by the user. That is, the display control unit 61 displays the input fields, in which the default values are input, in a case where the region JG5 is displayed on the operational screen P3.

In addition, in a case where the user clicks (taps) the tab TB4, the display control unit 61 displays an explanatory text according to the tab TB4 in the region GG1. In the example illustrated in FIG. 9, the explanatory text displayed by the display control unit 61 in the region GG1 is “It is smoothness of movement of the hand.”.

The button B12 is a button to delete all of values input by the user in each of the input fields of the region JG5 and to input default values according to parameters, which are to be input into each of the input fields, into each of the input fields. In a case where the user clicks (taps) the button B12 (that is, once the selection of the button B12 is received), the display control unit 61 deletes all of the values input by the user in each of the input fields and inputs default values according to parameters, which are to be input into each of the input fields, into each of the input fields.

In addition, on the operational screen P3 illustrated in FIG. 9, an image according to the tab TB4 is displayed in the region MM1. In a case where the user clicks (taps) the tab TB4, the display control unit 61 displays the image according to the tab TB4 instead of the image which has been displayed in the region MM1 until then. In an example illustrated in FIG. 9, a moving image, which is a result of performing three-dimensional simulation of operation of the robot 20 in a case where the robot 20 performs the task indicated by the task information selected by the user on the operational screen P2 illustrated in FIG. 5 through force control based on the parameters input in the region JG5, is displayed in the region MM1 as an image according to the tab TB4. In a case where the user inputs each of the parameters of force control in the input fields of the region JG5, the setting unit 63 sets each of parameters input in the input fields in the simulation unit 65. The simulation unit 65 performs three-dimensional simulation of operation of the robot 20 in a case where the robot 20 performs the task indicated by the task information selected by the user on the operational screen P2 illustrated in FIG. 5 through force control based on each of the parameters of force control set by the setting unit 63. Then, the simulation unit 65 generates a moving image, which is the result of this three-dimensional simulation. The display control unit 61 displays the moving image generated by the simulation unit 65 in the region MM1.

The button B7 is a button to correlate teaching point information indicating a teaching point (point), in which teaching point position information indicating a position displayed in the region JG2 illustrated in FIG. 6 (in this example, the task start position) and an orientation displayed in the region JG2 (in this example, the task start orientation) are correlated with each other, with a file name input in the file name input field CF2 and to store the information in the memory unit 52. That is, the file name input field CF2 is an input field into which the user inputs this file name. In addition, the button B7 is a button to correlate application force information, which is information indicating an application force input by the user in the region JG3 illustrated in FIG. 7, with a file name input in the file name input field CF3 and to store the information in the memory unit 52. That is, the file name input field CF3 is an input field into which the user inputs this file name. In addition, the button B7 is a button to correlate teaching information, in which the teaching point information, termination condition information indicating a termination condition input by the user in the region JG4 illustrated in FIG. 8, and parameter information indicating parameters of force control input by the user in the region JG5 illustrated in FIG. 9 are correlated with one another, with a file name input in the file name input field CF1 illustrated in FIG. 4 and FIG. 5 and to store the information in the memory unit 52.

In a case where the user clicks (taps) the button B7 (that is, once the selection of the button B7 is received), the memory control unit 67 specifies that the current position and orientation of the control point T, that is, a position and orientation that are displayed in the region JG2, are the task start position and the task start orientation. The memory control unit 67 generates teaching point information indicating a teaching point, in which teaching point position information indicating the specified task start position and teaching point orientation information indicating the task start orientation are correlated with each other. The memory control unit 67 correlates the generated teaching point information with a file name input in the file name input field CF2 and stores the information in the memory unit 52. In addition, in this case, the memory control unit 67 generates application force information indicating an application force input in an input field of the region JG3. The memory control unit 67 correlates the generated application force information with a file name input in the file name input field CF3 and stores the information in the memory unit 52. In addition, in this case, the memory control unit 67 generates termination condition information indicating a termination condition input in an input field of the region JG4 illustrated in FIG. 8. In addition, the memory control unit 67 generates parameter information indicating a parameter of force control input in an input field of the region JG5 illustrated in FIG. 9. The memory control unit 67 correlates teaching information, in which the generated teaching point information, the generated termination condition information, and the generated parameter information are correlated with one another, with a file name input in the file name input field CF1 and stores the information in the memory unit 52.

The button B8 is a button for the user to terminate operation, which is carried out on the operational screen P3, on the operational screen P3 illustrated in FIG. 6. In a case where the user clicks (taps) the button B8 (that is, once the selection of the button B8 is received), the transmission control unit 71 reads the latest teaching information, which is stored in the memory unit 52, from the memory unit 52. Then, the transmission control unit 71 outputs the read teaching information to the robot control device 40 and stores the information in the robot control device 40.

Processing of Receiving Parameter According to Task that Information Processing Device Causes Robot to Perform

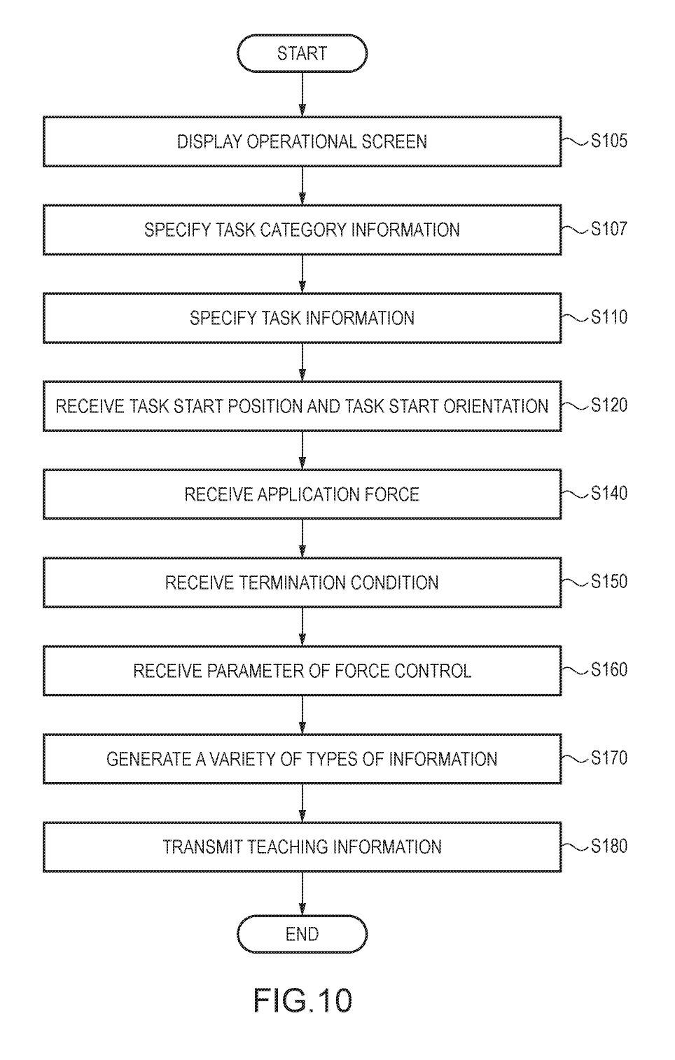

Hereinafter, processing of receiving a parameter according to a task that the information processing device 50 causes the robot 20 to perform from an operational screen will be described with reference to FIG. 10. FIG. 10 is a flowchart illustrating an example of flow of processing of receiving a parameter according to a task that the information processing device 50 causes the robot 20 to perform from an operational screen. Hereinafter, a case where the user selects the task category information C2 on the operational screen P1 and the user selects the task information S2 on the operational screen P2 will be described as an example.

The display control unit 61 reads task category information stored in advance in the memory unit 52 based on operation received from the user. The display control unit 61 generates the aforementioned operational screen P1 based on the read task category information. The display control unit 61 causes the display unit 55 to display the generated operational screen P1 (Step S105). Next, the display control unit 61 stands by until the button B1 is clicked (tapped) after the user selects the task category information C2 on the operational screen P1. In a case where the user clicks (taps) the button B1 after selecting the task category information C2 on the operational screen P1, the display control unit 61 specifies that task category information desired by the user is the task category information C2 (Step S107). Then, the display control unit 61 reads task information stored in advance in the memory unit 52. The display control unit 61 transitions the operational screen P1 to the operational screen P2 based on the read task information.

Next, the display control unit 61 stands by until the button B4 is clicked (tapped) after the user selects the task information S2 on the operational screen P2. In a case where the user clicks (taps) the button B4 after selecting the task information S2 on the operational screen P2, the display control unit 61 specifies that task information desired by the user is the task information S2 (Step S110). Then, the display control unit 61 transitions the operational screen P2 to the operational screen P3 illustrated in FIG. 6. In Step S110, the following processing will be described assuming that a file name is input by the user into the file name input field CF1.

Next, the display control unit 61 stands by until the user clicks (taps) the tab TB2 after matching the position and orientation of the control point T to a desired position and orientation, to which the user intends to match the position and orientation of the control point T by the user operating the jog key JG1 on the operational screen P3 illustrated in FIG. 6. In a case where the tab TB2 is clicked (tapped) after matching the position and orientation of the control point T to a desired position and orientation, to which the user intends to match the position and orientation of the control point T, by the user operating the jog key JG1 on the operational screen P3 illustrated in FIG. 6, the display control unit 61 receives a position and orientation displayed in the region JG2 as the task start position and the task start orientation (Step S120) and transitions the operational screen P3 illustrated in FIG. 6 to the operational screen P3 illustrated in FIG. 7. The following processing will be described assuming that filenames are input by the user in each of the file name input field CF2 and the file name input field CF3 in Step S120.

Next, the display control unit 61 stands by until the user clicks (taps) the tab TB3 after inputting a desired application force in an input field of the region JG3 on the operational screen P3 illustrated in FIG. 7. In a case where the user clicks (taps) the tab TB3 after inputting a desired application force in the input field of the region JG3 on the operational screen P3 illustrated in FIG. 7, the display control unit 61 receives the application force input in the input field (Step S140) and transitions the operational screen P3 illustrated in FIG. 7 to the operational screen P3 illustrated in FIG. 8.

Next, the display control unit 61 stands by until the user clicks (taps) the tab TB4 after inputting a desired termination condition in an input field of the region JG4 on the operational screen P3 illustrated in FIG. 8. In a case where the user clicks (taps) the tab TB4 after inputting a desired termination condition in the input field of the region JG4 on the operational screen P3 illustrated in FIG. 8, the display control unit 61 receives the termination condition input in the input field (Step S150) and transitions the operational screen P3 illustrated in FIG. 8 to the operational screen P3 illustrated in FIG. 9.

Next, the display control unit 61 stands by until the user clicks (taps) the button B7 after inputting a desired parameter of force control in an input field of the region JG5 on the operational screen P3 illustrated in FIG. 9. In a case where the user clicks (taps) the button B7 after inputting a desired parameter of force control in the input field of the region JG5 on the operational screen P3 illustrated in FIG. 9, the display control unit 61 receives the parameter of force control input in the input field (Step S160).

Next, the memory control unit 67 generates a variety of types of information (Step S170). Specifically, the memory control unit 67 generates teaching point position information indicating the task start position received by the display control unit 61 in Step S120 and teaching point orientation information indicating the task start orientation received by the display control unit 61 in Step S120. The memory control unit 67 generates teaching point information indicating a teaching point in which the generated teaching point position information and teaching point orientation information are correlated with each other. In addition, the memory control unit 67 generates application force information indicating the application force received by the display control unit 61 in Step S140. In addition, the memory control unit 67 generates termination condition information indicating the termination condition received by the display control unit 61 in Step S150. In addition, the memory control unit 67 generates parameter information indicating the parameter of force control received by the display control unit 61 in Step S160. In addition, the memory control unit 67 generates teaching information in which the generated teaching point information, the generated termination condition information, and the generated parameter information are correlated with one another. Then, the memory control unit 67 correlates the generated teaching point information with a file name input in the file name input field CF2 and stores the information in the memory unit 52. In addition, the memory control unit 67 correlates the generated application force information with a file name input in the file name input field CF3 and stores the information in the memory unit 52. In addition, the memory control unit 67 correlates the generated teaching information with a file name input in the file name input field CF1 and stores the information in the memory unit 52.

Next, the display control unit 61 stands by until the user clicks the button B8. In a case where the user clicks the button B8, the display control unit 61 deletes the operational screen P3 from the display unit 55. Then, the transmission control unit 71 outputs the latest teaching information out of pieces of teaching information stored in the memory unit 52 to the robot control device 40 and stores the information in the robot control device 40 (Step S180). After then, the control unit 56 terminates processing.

As in the above description, the information processing device 50 displays an operational screen by performing processing such as Step S105 to Step S180. Once selection of task information is received (that is, in a case where certain task information is selected by the user), the information processing device 50 receives a parameter according to a task of the robot 20 indicated by the selected task information and displays information indicating operation of the robot 20 based on the received parameter onto the operational screen. Accordingly, the information processing device 50 can cause the user to easily perform input of a parameter according to a task performed by the robot 20.

The sequence of processing of Step S120 to Step S160 in the above flow chart may be other sequences.

In addition, in the embodiment described above, the information processing device 50 may be configured such that the shape of each of the insertion object and insertion target object that are included in an image displayed in the region MM1 can be made into a shape desired by the user based on operation received from the user. In this case, the display control unit 61 generates at least one of an operational screen on which information indicating this shape is input and an operational screen on which information indicating this shape is selected and causes the display unit 55 to display the generated operational screen.

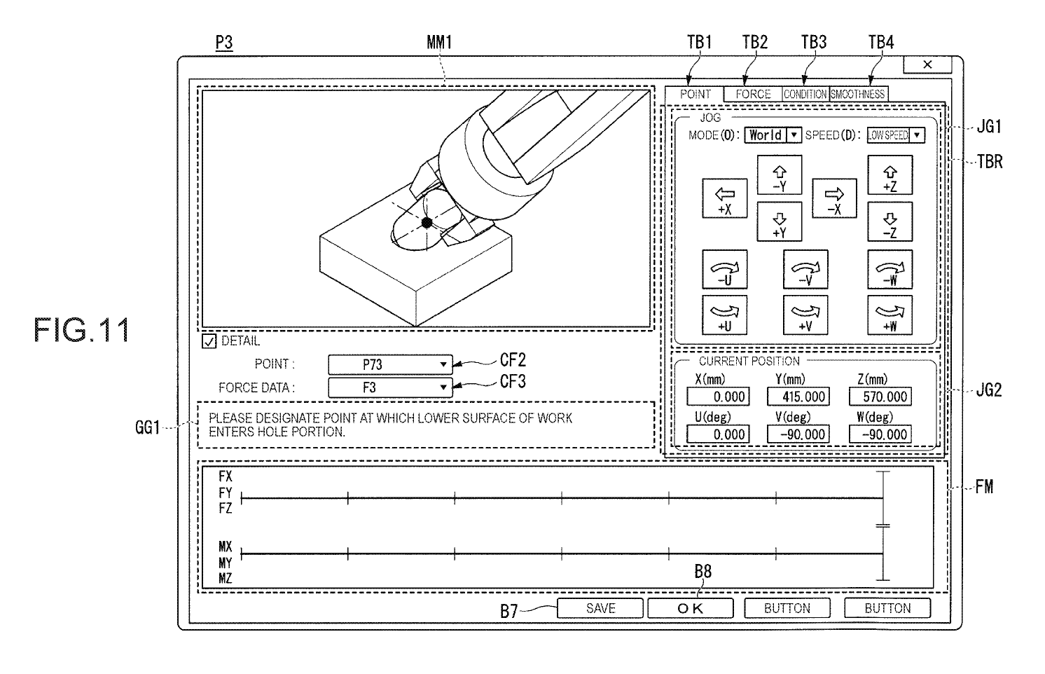

In addition, in Step S110, in a case where the user selects the task information S3 (that is, once the selection of the task information S3 is received), the display control unit 61 displays the operational screen P3 illustrated in FIG. 11 instead of the operational screen P3 illustrated in FIG. 6. FIG. 11 is a view illustrating an example of the operational screen P3 displayed in a case where the user selects the task information S3. In a task indicated by the task information S3, two-stage force control is performed. In first stage force control, the robot 20 changes the orientation of the insertion object through force control to match the orientation of the insertion object to an orientation, in which the insertion object is to be inserted into the insertion portion, by translating the insertion object in the insertion direction in a state where a part of the insertion object is inserted in the insertion portion by tilting the insertion object with respect to the insertion target object while moving the insertion object in the insertion direction. In second stage force control, the robot 20 inserts the insertion object in the insertion direction through force control.

The operational screen P3 illustrated in FIG. 11 is a screen that receives a task start position, a task start orientation, an application force, a termination condition, and a parameter of force control in such first stage force control. On the operational screen P3 illustrated in FIG. 11, an image displayed in the region MM1 is different from the image displayed in the region MM1 included in the operational screen P3 illustrated in FIG. 6. In addition, on the operational screen P3 illustrated in FIG. 11, an explanatory text displayed in the region GG1 is different from the explanatory text displayed in the region GG1 included in the operational screen P3 illustrated in FIG. 6.

An image according to the tab TB1 in the region MM1 illustrated in FIG. 11 is a three-dimensional still image indicating a state where a part of the insertion object is inserted by the robot 20 in the insertion portion by tilting the insertion object with respect to the insertion target object while moving the insertion object in the insertion direction. In addition, an explanatory text “Please designate a point at which the lower surface of the work enters the hole portion” is displayed in the region GG1 illustrated in FIG. 11 as an explanatory text according to the tab TB1.

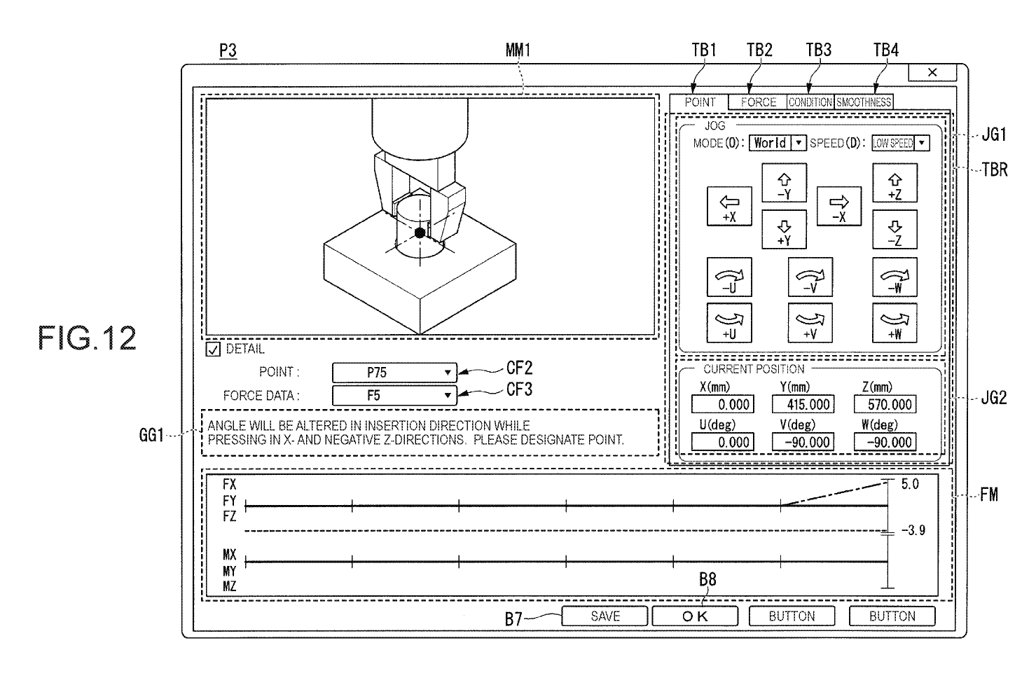

In a case where the task start position, the task start orientation, the application force, the termination condition, and the parameter of force control in the first stage force control are received on the operational screen P3 illustrated in FIG. 11, the display control unit 61 transitions the operational screen P3 illustrated in FIG. 11 to the operational screen P3 illustrated in FIG. 12. FIG. 12 is a view illustrating an example of the operational screen P3 after the task start position, the task start orientation, the application force, the termination condition, and the parameter of force control in such first stage force control are received.

The operational screen P3 illustrated in FIG. 12 is a screen that receives a task start position, a task start orientation, an application force, a termination condition, and a parameter of force control in the second stage force control. On the operational screen P3 illustrated in FIG. 12, an image displayed in the region MM1 is the same as the image displayed in the region MM1 included in the operational screen P3 illustrated in FIG. 6. These images may be images that are different from each other. In addition, on the operational screen P3 illustrated in FIG. 12, an explanatory text displayed in the region GG1 is different from the explanatory text displayed in the region GG1 included in the operational screen P3 illustrated in FIG. 6. In addition, “The angle will be altered in the insertion direction while pressing in an X- and negative Z-directions. Please designate a point.” is displayed in the region GG1 illustrated in FIG. 12 as an explanatory text according to the tab TB1.

As in the above description, the information processing device 50 can also receive a task start position, a task start orientation, an application force, a termination condition, and a parameter of force control in force control for each of a plurality of stages.

As described hereinbefore, the information processing device 50 (that is, the control apparatus 30) displays an operational screen (in this example, the operational screen P1 to the operational screen P3). Once selection of task information is received, the information processing device 50 receives a parameter according to a task of the robot 20 indicated by the selected task information (in this example, a parameter of force control) and displays information indicating operation of the robot 20 based on the received parameter onto the operational screen. Accordingly, the information processing device 50 can cause the user to easily perform input of a parameter according to a task performed by the robot 20.

In addition, in the information processing device 50, a part or the whole of task information indicating each of a plurality of tasks performed by the robot 20 is a task indicated by task information stored in advance in a memory unit (in this example, the memory unit 52). Accordingly, the information processing device 50 can cause the user to easily perform input of a parameter according to a task performed by the robot 20 based on the task information stored in the memory unit.

In addition, the information processing device 50 sets a parameter to a default value in a case where the parameter is not received. Accordingly, the information processing device 50 can cause the user to easily perform input of a parameter according to a task performed by the robot based on the default value of the parameter.

In addition, in a case where the user selects certain task information, the information processing device 50 receives a parameter for controlling the robot 20 based on an output value from the force detecting unit (in this example, the force detecting unit 21), which is a parameter according to a task of the robot 20 indicated by the selected task information, and displays information indicating operation of the robot 20 based on the received parameter onto the operational screen. Accordingly, the information processing device 50 can cause the user to easily perform input of the parameter for controlling the robot based on the output value from the force detecting unit, which is a parameter according to a task performed by the robot.

In addition, in a case where the user selects certain task information, the information processing device 50 receives a parameter for controlling the robot 20 through impedance control, which is a parameter according to a task of the robot 20 indicated by the selected task information and displays information indicating operation of the robot 20 based on the received parameter onto the operational screen. Accordingly, the information processing device 50 can cause the user to easily perform input of the parameter for controlling the robot 20 through impedance control, which is a parameter according to a task performed by the robot 20.

In addition, the information processing device 50 receives a termination condition to terminate control of the robot 20 based on the output value from the force detecting unit on an operational screen and displays information indicating operation of the robot 20 based on the received termination condition onto the operational screen. Accordingly, the information processing device 50 can cause the user to easily perform input of the termination condition to terminate control of the robot 20 based on the output value from the force detecting unit.

In addition, the information processing device 50 displays information which is based on the output value from the force detecting unit (in this example, a graph displayed in the region FM) onto the operational screen. Accordingly, based on the information, which is based on the output value from the force detecting unit and is displayed on the operational screen, the information processing device 50 can cause the user to easily perform input of the parameter for controlling the robot 20 based on the output value from the force detecting unit, which is a parameter according to a task performed by the robot 20.

In addition, once the selection of a button to store the parameter received from the operational screen in the memory unit is received, the information processing device 50 stores parameter information indicating the parameter in the memory unit. Accordingly, the information processing device 50 can output the parameter information stored in the memory unit to other devices (for example, the robot control device 40).

In addition, in a case where the user selects certain task information, the information processing device 50 receives a parameter according to a task of the robot 20 indicated by the selected task information and displays a simulation result of operation of the robot 20 based on the received parameter onto the operational screen. Accordingly, the information processing device 50 can cause the user to easily perform input of a parameter according to a task performed by the robot 20 based on the simulation result of the operation of the robot 20 displayed on the operational screen.

In addition, in a case where the user selects certain task information, the information processing device 50 receives a parameter according to a task of the robot 20 indicated by the selected task information and displays a three-dimensional simulation result of operation of the robot 20 based on the received parameter onto the operational screen. Accordingly, the information processing device 50 can cause the user to easily perform input of a parameter according to a task performed by the robot 20 based on the three-dimensional simulation result of the operation of the robot 20 displayed on the operational screen.

In addition, the robot 20 controlled by the control apparatus 30 can perform operation based on the parameter received by the control apparatus 30. Accordingly, the robot 20 can accurately perform a task including operation desired by the user.

Hereinbefore, although the embodiment of the invention has been described in detail with reference to the drawings, specific configurations are not limited to the embodiment. Alteration, substitution, and omission may be made without departing from the spirit of the invention.

In addition, a program for realizing a function of any configuration unit in the above-described device (for example, the information processing device 50, the robot control device 40, and the control apparatus 30) may be recorded in a computer readable recording medium, and the program may be executed by causing a computer system to read the program. Herein the “computer system” refers to an operating system (OS) or hardware including a peripheral device. In addition, the “computer readable recording medium” refers to a portable medium, including a flexible disk, a magneto-optical disk, a ROM, and a compact disk (CD)-ROM, and a memory device, including a hard disk mounted in the computer system. The “computer readable recording medium” further refers to a recording medium that retains a program for a certain amount of time, such as a volatile memory (RAM) inside the computer system, which becomes a server or a client, in a case where the program is transmitted via a network, including the Internet, or a via communication circuit, including a telephone line.

In addition, the program may be transmitted to other computer systems from the computer system which stores the program in the memory device or the like via a transmission medium or via a carrier wave within the transmission medium. Herein, the “transmission medium” which transmits the program refers to a medium having a function of transmitting information, such as a network (communication network), including the Internet, and a communication circuit (communication line) including a telephone line.

In addition, the program may be a program for realizing a part of the aforementioned function. Furthermore, the program may be a program that can realize the aforementioned function in combination with a program already recorded in the computer system, in other words, a differential file (differential program).

The entire disclosure of Japanese Patent Application No. 2016-149434, filed Jul. 29, 2016 is expressly incorporated by reference herein.

What is claimed is:

1. A control apparatus comprising:
a processor that is configured to execute computer-executable instructions so as to control a robot,
wherein the processor is configured to:
cause a display unite to display an operational screen, on which task information indicating each of a plurality of tasks performed by a robot provided with a force detecting unit is displayed;
receive a parameter according to a task of the robot, which is indicated by selected task information once the processor receives the selection of the task information; and
cause the display unite to display information indicating operation of the robot based on the received parameter.

2. The control apparatus according to claim 1,
wherein a part or the whole of the plurality of tasks is a task indicated by task information stored in advance in a memory unit.

3. The control apparatus according to claim 1,
wherein a default value of the parameter according to the task, which is indicated by the selected task information, is determined in advance, and
the parameter is set to the default value in a case where the processor does not receive the parameter is not received.

4. The control apparatus according to claim 1,
wherein the parameter is a parameter for controlling the robot based on an output value from the force detecting unit.

5. The control apparatus according to claim 4,
wherein control based on the output value is impedance control, and
the parameter is an impedance parameter.

6. The control apparatus according to claim 4,
wherein the processor is configured to receive a termination condition to terminate control of the robot based on the output value and cause the display unite to display information based on the received termination condition.

7. The control apparatus according to claim 4,
wherein the processor is configured to cause the display unite to display information based on the output value.

8. The control apparatus according to claim 1,
wherein a button to store the parameter received from the operational screen in a memory unit is included in the operational screen, and
the processor is configured to store parameter information indicating the parameter in the memory unit once the processor receives selection of the button.

9. The control apparatus according to claim 1,
wherein the information is a result of performing simulation of the operation.

10. The control apparatus according to claim 9,
wherein the simulation is three-dimensional simulation.

11. A robot that is controlled by the control apparatus according to claim 1.

12. A robot that is controlled by the control apparatus according to claim 2.

13. A robot that is controlled by the control apparatus according to claim 3.

14. A robot that is controlled by the control apparatus according to claim 4.

15. A robot that is controlled by the control apparatus according to claim 5.

16. A robot that is controlled by the control apparatus according to claim 6.

17. A robot that is controlled by the control apparatus according to claim 7.

18. A robot that is controlled by the control apparatus according to claim 8.

19. A robot that is controlled by the control apparatus according to claim 9.

20. A robot that is controlled by the control apparatus according to claim 10.
